(19) United States
(12) Patent Application Publication
(10) Pub. No.: US 2013/0103442 A1
(43) Pub. Date: Apr. 25, 2013

(54) DYNAMIC RESTAURANT POSITIONING SYSTEM AND METHOD

(71) Applicants: Mike Burks, Chicago, IL (US); Tim Chapman, Geneva, IL (US); Kathy Dorsey, Naperville, IL (US); Fernando Gomez Gonzalez, North Aurora, IL (US); Ronald R. Halverson, Oak Park, IL (US); Mark Anthony Krauss, Sugar Grove, IL (US); Trevor Kunkle, Chicago, IL (US); Michael Lewis, Bolingbrook, IL (US)

(72) Inventors: Mike Burks, Chicago, IL (US); Tim Chapman, Geneva, IL (US); Kathy Dorsey, Naperville, IL (US); Fernando Gomez Gonzalez, North Aurora, IL (US); Ronald R. Halverson, Oak Park, IL (US); Mark Anthony Krauss, Sugar Grove, IL (US); Trevor Kunkle, Chicago, IL (US); Michael Lewis, Bolingbrook, IL (US)

(73) Assignee: Restaurant Technology, Inc., St. Charles, IL (US)

(21) Appl. No.: 13/277,202

(22) Filed: Oct. 19, 2011

(51) Int. Cl. G06Q 10/06; G06Q 50/12

(52) U.S. Cl. 705/7.13

(57) ABSTRACT

A system for managing restaurant crew member staffing comprises a computer having memory for receiving configuration data corresponding to a restaurant associated with a group of restaurants, first data corresponding to a projected consumer demand for items at the restaurant over a time increment, and second data corresponding to a historical consumer demand for items at the restaurant over the time increment, a computer-readable medium encoded with a computer program adapted to dynamically determine a quantity of crew members needed and a position for each crew member determined to be needed to staff each of a plurality of work areas at the restaurant over a plurality of the time increments based on the configuration data, the first data, and the second data, and a computer display for displaying the quantity of crew members needed to meet the projected consumer demand over the plurality of time increments, and the work areas to which each of the determined quantity of crew members should be assigned.

### CROSS-REFERENCE TO RELATED APPLICATION

This application is being filed simultaneously with U.S. patent application Ser. No. ______, entitled “DYNAMIC RESTAURANT POSITIONING SYSTEM AND METHOD”, Attorney Docket No. 19592.05US1, which is incorporated herein by reference without claiming such subject matter.

### BACKGROUND OF THE INVENTION

This invention relates generally restaurant operation optimization methods, and more particularly, to systems and methods for optimizing and determining the number of restaurant crew needed during each time increment in a shift, as well as the positions for assigning each crew member during each time increment.

Predicting the number of employees needed for a shift at a restaurant, and accurately predicting where each employee should be positioned or stationed within the restaurant at each hour during the shift, can be a daunting challenge. Customer demand fluctuates throughout a day, sometimes dramatically. Customer demand also fluctuates from day to day, week to week, month to month, and season to season. Adding to the challenge is the complexity brought by different restaurant configurations and product diversity and availability among a family or group of restaurants sometimes spanning different continents and cultures. Consequently, a one-size-fits-all tool to predict the labor needs of a particular restaurant among a plurality of restaurants, such as a brand of restaurants, during each time increment within a shift is insufficient to efficiently meet the operational standards and demand of each particular restaurant.

### SUMMARY OF THE INVENTION

A method for managing restaurant crew member staffing is disclosed, comprising the steps of receiving at a computer processor over a computer network from a database computer configuration data corresponding to a restaurant associated with a group of restaurants, receiving at the computer processor over a computer network from the database computer first data corresponding to a projected consumer demand for items at the restaurant over a time increment, adjusting using the computer processor a maximum transaction capability for a quantity of crew members required to fulfill the projected consumer demand to account for differences between the projected consumer demand at the restaurant to a historical consumer demand at a plurality of the group of restaurants, and dynamically determining using the computer processor the quantity of crew members needed over a predicted time increment based on the adjusted maximum transaction capability.

The configuration data may define at least one of a plurality of work areas, relative location of the work areas with respect to one another, work area equipment, order taking configuration, and types of items available to be sold. The order taking configuration may comprise a definition of at least one of a drive thru configuration and a front counter configuration. The configuration data may comprise a definition of at least one of a drive thru layout, quantity, and/or position; a layout, quantity and/or position of front counter registers; a layout, quantity, and/or position of grills; a layout, quantity and/or position of fried product fryers; a layout, quantity, and/or position of beverage dispensers; a layout, quantity, and/or position of beverage distribution areas; a layout, quantity, and/or position of order assembly areas; a layout, quantity, and/or position of food production line areas; a layout, quantity, and/or position of order delivery areas; a layout, quantity, and/or position of dessert areas (such as dessert kiosks); and/or a quantity and/or position of satellite locations for product distribution. The time increment may be a plurality of shifts, a shift, an hour, or a fraction of an hour. One or more of the above areas can alternatively or additionally be in the form of a kiosk.

The projected consumer demand may comprise at least one of a historical quantity of consumer transactions over the time increment corresponding to the restaurant, a historical quantity of items ordered per transaction corresponding to the restaurant, and a historical type of each item ordered per transaction corresponding to the restaurant. The quantity of consumer transactions may comprise a quantity of drive thru transactions and a quantity of front counter transactions

The method may comprise the step of dynamically determining crew member utilization data per work area over the time increment. The method may also comprise the step of using the crew member utilization data to reassign at least one crew member to another work area. The method may further comprise the step of displaying, on a computer display, at least a portion of the configuration data together with a graphical depiction of the positioning and sequence of positioning of each crew member needed. The method may also comprise the step of dynamically determining a sequence at which the crew members are positioned at or removed from respective work areas. The method may further comprise the step of dynamically determining at least one additional work area corresponding to at least one additional crew member above the adjusted crew member quantity needed to be positioned for real-time positioning of the at least one additional crew member in the event of a higher than expected consumer demand. The method may also comprise the step of dynamically determining a plurality of secondary duties to assign to each of the crew members for permitting a rapid repositioning of the crew members to balance crew workload against actual consumer demand.

The step of adjusting a maximum transaction capability for a quantity of crew members required to fulfill the projected consumer demand may comprise adjusting a maximum transaction capability for crew members assigned to at least one of a Drive-Thru work area and a Front Counter work area.

In another embodiment, a method for managing restaurant crew member staffing is disclosed, comprising the steps of receiving at a computer processor over a computer network from a database computer configuration data corresponding to a restaurant associated with a group of restaurants, receiving at the computer processor over a computer network from the database computer first data corresponding to a projected consumer demand for items at the restaurant over a time increment, and dynamically determining the quantity of crew members needed over a predicted time increment based on a normalized maximum transaction capability. The projected consumer demand may comprise a historical quantity of consumer transactions over the time increment corresponding to the restaurant, a historical quantity of items ordered per transaction corresponding to the restaurant, and a historical type of each item ordered per transaction corresponding to the restaurant.

The normalized maximum transaction capability may account for differences between the projected consumer demand at the restaurant to a historical consumer demand at a plurality of the group of restaurants. The configuration data may define a plurality of work areas, relative location of the work areas with respect to one another, work area equipment, and types of items available to be sold. The time increment may be an hour or a fraction of an hour. The quantity of consumer transactions may comprise a quantity of drive thru transactions and a quantity of front counter transactions.

The method may comprise the step of dynamically determining crew member utilization data per work area over the time increment, the step of using the crew member utilization data to reassign at least one crew member to another work area, and the step of displaying, on a computer display, at least a portion of the configuration data together with a graphical depiction of the positioning and sequence of positioning of each crew member needed. The method may also comprise the step of dynamically determining a sequence at which the crew members are positioned at or removed from respective work areas, the step of dynamically determining at least one additional work area corresponding to at least one additional crew member above the adjusted crew member quantity needed to be positioned for real-time positioning of the at least one additional crew member in the event of a higher than expected consumer demand, and the step of dynamically determining a plurality of secondary duties to assign to each of the crew members for permitting a rapid repositioning of the crew members to balance crew workload against actual consumer demand.

The step of adjusting a maximum transaction capability for a quantity of crew members required to fulfill the projected consumer demand may comprise adjusting a maximum transaction capability for crew members assigned to at least one of a Drive-Thru work area and a Front Counter work area.

In another embodiment, a computer program product stored on a computer-readable medium is disclosed. The computer program product has computer-executable code instructions that are executable by a computer processor for managing restaurant crew member staffing and positioning assignments. The computer-executable code instructions include first code instructions for receiving configuration data corresponding to a restaurant associated with a group of restaurants; second code instructions for receiving first data corresponding to a projected consumer demand for items at the restaurant over the time increment; third code instructions for receiving second data corresponding to a transaction capability per crew member over the time increment; fourth code instructions for dynamically determining a crew member quantity needed over a predicted time increment; and fifth code instructions for adjusting the crew member quantity needed over the predicted time increment to account for differences in the transaction capability per crew member over the predicted time increment for the restaurant as compared to a plurality of restaurants associated with the group of restaurants.

The computer program product may comprise sixth code instructions for dynamically determining a sequence at which crew members are positioned at or removed from respective work areas over the predicted time increment. The computer program product may comprise seventh code instructions for dynamically determining a plurality of secondary duties to assign to each of the crew members for permitting a rapid repositioning of the crew members to balance crew workload against actual consumer demand.

The computer program product may comprise eighth code instructions for displaying, on a computer display, a plurality of crew member sequencing and positioning scenarios side by side.

In another embodiment, a system for managing restaurant crew member staffing is disclosed, comprising a computer having memory for receiving configuration data corresponding to a restaurant associated with a group of restaurants, first data corresponding to a projected consumer demand for items at the restaurant over a time increment, and second data corresponding to a historical consumer demand for items at the restaurant over the time increment; a computer-readable medium encoded with a computer program adapted to dynamically determine a quantity of crew members needed and a position for each crew member determined to be needed to staff each of a plurality of work areas at the restaurant over a plurality of the time increments based on the configuration data, the first data, and the second data; and a computer display for displaying the quantity of crew members needed to meet the projected consumer demand over the plurality of time increments, and the work areas to which each of the determined quantity of crew members should be assigned.

The system may comprise a display of a plurality of crew member staffing scenarios displayed side by side. The configuration data may comprise at least one of a relative location of the work areas with respect to one another, work area equipment, order taking configuration of the restaurant, and types of items available to be sold. The configuration data may comprise a definition of at least one of a drive thru layout, quantity, and/or position; a layout, quantity and/or position of front counter registers; a layout, quantity, and/or position of grills; a layout, quantity and/or position of fried product fryers; a layout, quantity, and/or position of beverage dispensers; a layout, quantity, and/or position of beverage distribution areas; a layout, quantity, and/or position of order assembly areas; a layout, quantity, and/or position of food production line areas; a layout, quantity, and/or position of order delivery areas; a layout, quantity, and/or position of dessert areas (such as dessert kiosks); and/or a quantity and/or position of satellite locations for product distribution. The time increment may be a plurality of shifts, a shift, an hour, or a fraction of an hour. One or more of the above areas can alternatively or additionally be in the form of a kiosk.

The first data and the second data may comprise a quantity of items per order associated with at least one work area. The first data and the second data may comprise a plurality of types of items per order.

The determination of the quantity of crew members needed to staff each of the plurality of work areas may include a comparison of a projected quantity of items per order to be fulfilled per work area over the time increment to an order fulfillment capacity for each respective work area over the time increment.

The system may further comprise a computer-readable medium encoded with a computer program adapted to dynamically determine a sequence for positioning at the respective work areas each of the crew members determined to be needed. The determination of the sequence may comprise sorting each of the positioned crew members according to a minimum fulfillment capacity.

In another embodiment, a method for managing restaurant crew member staffing is disclosed, comprising the steps of receiving at a computer processor from a database configuration data corresponding to a restaurant associated with a group of restaurants, receiving at the computer processor from the database first data corresponding to a projected consumer demand for items at the restaurant over a time increment, adjusting using the computer processor a transaction capability for a quantity of crew members required to fulfill the projected consumer demand while taking into account the configuration data, the adjustment accounting for differences between the projected consumer demand at the restaurant to a historical consumer demand associated with the group of restaurants, and dynamically determining using the computer processor the quantity of crew members needed over a predicted time increment based on the adjusted transaction capability.

The configuration data may define at least one of a plurality of work areas, relative location of the work areas with respect to one another, work area equipment, order taking configuration, and types of items available to be sold. The order taking configuration may comprise a definition of at least one of a drive thru configuration and a front counter configuration. The configuration data may comprise a definition of at least one of a drive thru layout, a quantity of front counter registers, a quantity and/or position of grills, a quantity and/or position of fried product fryers, and/or a quantity and/or position of beverage dispensers. The time increment may comprise a plurality of shifts, a shift, an hour, or a fraction of an hour.

The projected consumer demand may comprise at least one of a historical quantity of consumer transactions over the time increment corresponding to the restaurant, a historical quantity of items ordered per transaction corresponding to the restaurant, and/or a historical type of each item ordered per transaction corresponding to the restaurant. The quantity of consumer transactions may comprise a quantity of drive thru transactions and a quantity of front counter transactions.

The historical consumer demand associated with the group of restaurants may comprise at least one of a historical quantity of consumer transactions over the time increment corresponding to the group of restaurants, a historical quantity of items ordered per transaction corresponding to the group of restaurants, and/or a historical type of each item ordered per transaction corresponding to the group of restaurants.

The method may comprise the step of dynamically determining crew member utilization data per work area over the time increment. The method may also comprise the step of using the crew member utilization data to reassign at least one crew member to another work area. The crew member utilization data may dynamically adjust in real-time according to actual consumer demand for items at the restaurant over the time increment.

The method may comprise the step of displaying, on a computer display, at least a portion of the configuration data together with a graphical depiction of the positioning and sequence of positioning of each crew member needed. The method may comprise the step of dynamically determining a sequence at which the crew members are positioned at or removed from respective work areas. The method may further comprise the step of dynamically determining at least one additional work area corresponding to at least one additional crew member above the adjusted crew member quantity needed to be positioned for real-time positioning of the at least one additional crew member in the event of a higher than expected consumer demand. The method may also comprise the step of dynamically determining a plurality of secondary duties to assign to each of the crew members for permitting a rapid repositioning of the crew members to balance crew workload against actual consumer demand.

The step of adjusting a transaction capability for a quantity of crew members required to fulfill the projected consumer demand may comprise adjusting at least one of a maximum and a minimum transaction capability for crew members associated with a plurality of work areas.

In another embodiment, a method for managing restaurant crew member staffing is disclosed, comprising the steps of receiving at a computer processor from a database projected consumer demand for items at a restaurant over a time increment, the projected consumer demand comprising a historical quantity of consumer transactions over the time increment corresponding to the restaurant, a historical quantity of items ordered per transaction corresponding to the restaurant, and a historical type of each item ordered per transaction corresponding to the restaurant, and dynamically determining using the computer processor a quantity of crew members needed to staff a plurality of work areas of the restaurant over a predicted time increment according to a normalized transaction capability of the crew members.

The normalized transaction capability may account for differences between the projected consumer demand at the restaurant to a historical consumer demand associated with a group of restaurants for a given quantity of items per transaction. The step of determining the quantity of crew members needed may comprise using configuration data associated with the restaurant, the configuration data defining the plurality of work areas, relative location of the work areas with respect to one another, work area equipment, and types of items available to be sold.

The method may also comprise the step of displaying, on a computer display, at least a portion of the configuration data together with a graphical depiction of the positioning and sequence of positioning of each crew member needed. The method may further comprise the step of dynamically determining crew member utilization data per work area over the time increment. The method may also comprise the step of using the crew member utilization data to reassign at least one crew member to another work area.

The method may comprise the step of dynamically determining a sequence at which the crew members are positioned at or removed from respective work areas. The method may also comprise the step of dynamically determining at least one additional work area corresponding to at least one additional crew member above the crew member quantity needed for real-time positioning of the at least one additional crew member in the event of a higher than expected consumer demand. The method may further comprise the step of dynamically determining a plurality of secondary duties to assign to each of the crew members for permitting rapid repositioning of the crew members to balance crew workload against actual consumer demand.

In another embodiment, a computer program product stored on a computer-readable medium is disclosed, the computer program product having computer-executable code instructions that are executable by a computer processor for managing restaurant crew member staffing, the computer-executable code instructions comprising first code instructions for receiving at the computer processor from a database configuration data corresponding to a restaurant associated with a group of restaurants, second code instructions for receiving first data at the computer processor from the database at the computer processor corresponding to a projected consumer demand for items at the restaurant over a time increment, third code instructions for adjusting using the computer processor a transaction capability for a quantity of crew members required to fulfill the projected consumer demand while taking into account the configuration data, the adjustment accounting for differences between the projected consumer demand at the restaurant to a historical consumer demand associated with the group of restaurants, and fourth code instructions for dynamically determining using the computer processor the quantity of crew members needed over a predicted time increment based on the adjusted transaction capability.

In another embodiment, a computer program product stored on a computer-readable medium is disclosed, the computer program product having computer-executable code instructions that are executable by a computer processor for managing restaurant crew member staffing, the computer-executable code instructions comprising first code instructions for receiving at the computer processor from a database projected consumer demand for items at a restaurant over a time increment, the projected consumer demand comprising a historical quantity of consumer transactions over the time increment corresponding to the restaurant, a historical quantity of items ordered per transaction corresponding to the restaurant, and a historical type of each item ordered per transaction corresponding to the restaurant, and second code instructions for dynamically determining using the computer processor a quantity of crew members needed to staff a plurality of work areas of the restaurant over a predicted time increment according to a normalized transaction capability of the crew members.

In another embodiment, a system for managing restaurant crew member staffing is disclosed, comprising a computer having memory for receiving configuration data corresponding to a restaurant associated with a group of restaurants, first data corresponding to a projected consumer demand for items at the restaurant over a time increment, and second data corresponding to a historical consumer demand for items at the restaurant over the time increment, a computer-readable medium encoded with a computer program adapted to dynamically determine a quantity of crew members needed and a position for each crew member determined to be needed to staff each of a plurality of work areas at the restaurant over a plurality of the time increments based on the configuration data, the first data, and the second data, and a computer display for displaying the quantity of crew members needed to meet the projected consumer demand over the plurality of time increments, and the work areas to which each of the determined quantity of crew members should be assigned.

The system may also comprise a computer-readable medium encoded with a computer program adapted to cause the computer display to simultaneously display for each time increment a plurality of crew member staffing scenarios. The configuration data may comprise at least one of a relative location of the work areas with respect to one another, work area equipment, order taking configuration of the restaurant, and types of items available to be sold. The configuration data may comprise a definition of at least one of a drive thru layout, a quantity of front counter registers, a quantity and/or position of grills, a quantity and/or position of fried product fryers, and/or a quantity and/or position of beverage dispensers.

The first data and the second data may comprise a quantity of items per order associated with at least one work area. The first data and the second data may comprise a plurality of types of items per order.

Determination of the quantity of crew members needed to staff each of the plurality of work areas may comprise a comparison of a projected quantity of items per order to be fulfilled per work area over the time increment to an order fulfillment capacity for each respective work area over the time increment.

The system may comprise a computer-readable medium encoded with a computer program adapted to dynamically adjust an order fulfillment capacity for each respective work area of the restaurant over the time increment based on a historical order fulfillment of the group of restaurants. The system may also comprise a computer-readable medium encoded with a computer program adapted to dynamically determine a sequence for positioning at the respective work areas each of the crew members determined to be needed. Determination of the sequence may comprise sorting each of the positioned crew members according to a minimum fulfillment capacity. The system may comprise a computer-readable medium encoded with a computer program adapted to cause the computer display to dynamically display for each time increment a layout of the restaurant together with the sequence and positioning of each of the positioned crew members.

In another embodiment, a method for managing restaurant crew member staffing is disclosed, comprising the steps of receiving at a computer processor configuration data corresponding to a restaurant associated with a group of restaurants, first data corresponding to a projected consumer demand for items at the restaurant over a time increment, and second data corresponding to a historical consumer demand for items at the restaurant over the time increment, dynamically determining by the computer processor a quantity of crew members needed and a position for each crew member determined to be needed to staff each of a plurality of work areas at the restaurant over a plurality of the time increments based on the configuration data, the first data, and the second data, and displaying on a computer display the quantity of crew members needed to meet the projected consumer demand over the plurality of time increments, and the work areas to which each of the determined quantity of crew members should be assigned.

The method may further comprise the step of displaying a plurality of crew member staffing scenarios on the computer display at the same time. The configuration data may comprise at least one of a relative location of the work areas with respect to one another, work area equipment, order taking configuration of the restaurant, and types of items available to be sold. The configuration data may comprise a definition of at least one of a drive thru layout, a quantity of front counter registers, a quantity and/or position of grills, a quantity and/or position of fried product fryers, and/or a quantity and/or position of beverage dispensers.

The first data and the second data may comprise a quantity of items per order associated with at least one work area. The first data and the second data may comprise a plurality of types of items per order.

Determining the quantity of crew members needed to staff each of the plurality of work areas may comprise comparing a projected quantity of items per order to be fulfilled per work area over the time increment to an order fulfillment capacity for each respective work area over the time increment. The method may further comprise the step of dynamically determining a sequence for positioning at the respective work areas each of the crew members determined to be needed. The step of determining the sequence may comprise sorting each of the positioned crew members according to a minimum fulfillment capacity. The method may further comprise the step of dynamically displaying for each time increment a layout of the restaurant together with the sequence and positioning of each of the positioned crew members.

In another embodiment, a computer program product stored on a computer-readable medium is disclosed. The computer program product has computer-executable code instructions that are executable by a computer processor for managing restaurant crew member staffing and positioning assignments. The computer-executable code instructions comprise first code instructions for receiving configuration data corresponding to a restaurant associated with a group of restaurants, first data corresponding to a projected consumer demand for items at the restaurant over a time increment, and second data corresponding to a historical consumer demand for items at the restaurant over the time increment, second code instructions for dynamically determining a quantity of crew members needed and a position for each crew member determined to be needed to staff each of a plurality of work areas at the restaurant over a plurality of the time increments based on the configuration data, the first data, and the second data, and third code instructions for displaying on a computer display the quantity of crew members needed to meet the projected consumer demand over the plurality of time increments, and the work areas to which each of the determined quantity of crew members should be assigned.

The computer program product may further comprise fourth code instructions for simultaneously displaying a plurality of crew member staffing scenarios on the computer display. The configuration data may comprise at least one of a relative location of the work areas with respect to one another, work area equipment, order taking configuration of the restaurant, and types of items available to be sold. The configuration data may comprise a definition of at least one of a drive thru layout, a quantity of front counter registers, a quantity and/or position of grills, a quantity and/or position of fried product fryers, and/or a quantity and/or position of beverage dispensers.

The first data and the second data may comprise a quantity of items per order associated with at least one work area. The first data and the second data may comprise a plurality of types of items per order.

Determining the quantity of crew members needed to staff each of the plurality of work areas may comprise comparing a projected quantity of items per order to be fulfilled per work area over the time increment to an order fulfillment capacity for each respective work area over the time increment. The computer program product may further comprise fifth code instructions for dynamically determining a sequence for positioning at the respective work areas each of the crew members determined to be needed. Determining the sequence may comprise sorting each of the positioned crew members according to a minimum fulfillment capacity. The computer program product may comprise sixth code instructions for dynamically displaying for each time increment a layout of the restaurant together with the sequence and positioning of each of the positioned crew members.

### BRIEF DESCRIPTION OF THE DRAWINGS

For a better understanding of the invention, reference may be had to preferred embodiments shown in the following drawings in which:

FIG. 1 shows an exemplary embodiment of a flow diagram for a dynamic positioning system and method, or Dynamic Restaurant/Shift Positioning Tool (DRPT/DSPT);

FIG. 2 illustrates an exemplary collection of standard reference tables according to a particular restaurant configuration and day-part, such as for example, breakfast, lunch, or dinner;

FIG. 3 shows a detailed flow diagram of an exemplary DSPT;

FIG. 4 shows an exemplary block diagram for determining the number of employees needed for any given work area in a restaurant;

FIG. 5 shows exemplary variable labor hour (VLH) tables for respective positions or work areas in a restaurant;

FIG. 6 shows an exemplary adjustment to a portion of the tables shown in FIG. 5;

FIG. 7 shows an exemplary graphical output of a DSPT showing a staffing sequence for positioning employees in a restaurant;

FIG. 8 shows adjusted variable labor hour tables for each respective position or work area in a restaurant;

FIG. 9 shows an exemplary graphical output of a DSPT showing a staffing sequence for positioning employees in a restaurant;

FIG. 10 shows the result of an exemplary utilization computation reflecting projected restaurant area work load utilization compared to maximum restaurant area capacity;

FIG. 11 shows an exemplary graphical display of restaurant area utilization;

FIG. 12 shows a representative graphical user interface for selecting various inputs for a DSPT;

FIG. 13 shows a graphical user interface display for a representative secondary duty configuration for a restaurant;

FIG. 14 shows a representative Dynamic Shift Positioning Guide (DSPG) output resulting from operation of a DSPT for a restaurant;

FIG. 15 shows a detailed view of a portion of a representative DSPG output;

FIG. 16 shows a detailed view of a portion of a representative DSPG output;

FIG. 17 shows a detailed view of a portion of a representative DSPG output;

FIG. 18 shows a detailed view of a portion of a representative DSPG output;

FIG. 19 shows a detailed view of a portion of a representative DSPG output; and

FIG. 20 shows a representative computer on which an exemplary DSPT may operate.

DEFINITIONS

| ACRONYM | DEFINITION |
|---|---|
| DSPT | Dynamic Shift Positioning Tool |
| DSPG | Dynamic Shift Positioning Guide |
| VLH | Variable Labor Hour |
| CPU | Central Processing Unit |
| GUI | Graphical User Interface |
| RAM | Random Access Memory |
| XML | Extensible Markup Language |
| FC | Front Counter |
| DT | Drive Thru |
| ISP | In Store Processor |
| GC | Guest Count |
| CC | Customer Count |
| TC | Transaction Count |
| PC Cut Off | Maximum Capability of Available Crew Per Area |
| DT % | Percent of the Total Transaction Volume |
| | Processed By Drive Thru Windows of a Restaurant |
| Crew Headcount | Total Number of Employees on Station at |
| | Any Given Time During a Work Day |
| Area-Wise | Number of Employees at a Particular Work Station |
| Headcount | |

### DETAILED DESCRIPTION

The description that follows describes, illustrates and exemplifies one or more particular embodiments of the present invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the present invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers in cases where such labeling facilitates a more clear description. Additionally, the drawings set forth herein are not necessarily drawn to scale, and in some instances proportions may have been exaggerated to more clearly depict certain features.

In accordance with the principles of the present invention, one or more algorithms or analyses may be applied, alone or in combination, to a set of data to produce a tangible and useful result indicative of authorized-user-related issues. In a particular embodiment, characteristics are defined and determined for a specific set of data, resulting in useful statistics indicative of authorized-user-related issues. Data for specific files may be processed in light of these characteristics and an output specific to those files and related to those characteristics can be generated for use and analysis, which will be described in more detail later.

An embodiment of the invention is directed to a software tool that enables a restaurant manager, such as a manager of one or more fast food restaurants, to optimally determine the number of employees to assign to a given shift as well as the optimal workstation/position for each such employee during the shift to increase workplace efficiency, productivity, and sales, with a goal of enhancing customer satisfaction and experience. This is especially true at quick service restaurants (QSRs) where long lines mean lost customers. Indeed, staffing a restaurant, such as a QSR, with an insufficient number of employees or positioning a sufficient number of employees at incorrect or inefficient positions relative to a given customer demand may result in decreased labor efficiency, increased order taking and fulfillment times, and increased errors in delivered products, potentially resulting in reduced customer and employee experiences and negative impact to restaurant sales and profit. In addition, imbalances of workload among employees in a QSR where most of the employees are paid at similar hourly rates, may cause disfunction among the crew.

QSRs among a family or group of restaurants, may include, for example, one or more restaurant configurations, including, for example, one or more drive-thru windows, a front counter, a grill area, a french fry area, and a beverage area to name a few. The restaurant configuration may vary among each of the restaurants among the group of restaurants, and may vary relative to a standard configuration or layout of the group of restaurants. In addition, the group of restaurants may provide food items to its customers according to a breakfast menu, a lunch menu, a dinner menu, or any combination of such menus. In QSRs, crew member employees may be interchangeably assignable to one or more different workstations or positions in the restaurant. A group of restaurants may include a brand of restaurants, such as McDonald's.

Customer demand for food items at a given restaurant among a group of restaurants may vary throughout a given day, week, month, season, and year. Demand at a given restaurant may be measured in any number of ways and over one or more different time increments. For example, demand may be measured in terms of gross or net sales volume in units of a currency, number of customer purchase transactions, number of items per transaction, an identification of the mix of products purchased per transaction, and the like, with each of the foregoing metrics being measureable over, for example, an hour or parts of an hour, a shift, a “day part” (which may comprise a segment of a shift, such as, lunch, breakfast, or dinner), half-daily, daily, weekly, monthly, and yearly, or any combination or variation of time increment thereof. Demand may additionally be measured

In one embodiment, the software tool comprises a Dynamic Shift Positioning Tool (DSPT) 100, including a system and/or method. DSPT 100 may be configured to create a custom shift floor plan for the selected shift length to determine an optimal number of employees to assign to the selected shift as well as the best position for each employee to meet an anticipated customer demand. The customized floor plan will meet the unique needs of each restaurant in a group of restaurants by utilizing the local restaurant's data residing on its In Store Processor (ISP) or local computer system. In certain embodiments, the ISP or “local” computer system is not actually located at the store. In such a case, the application(s) and DSPT 100 and associated hardware/software can reside at a remote location, such as through an Application Service Provider (ASP) or similar arrangement, which can be dedicated to that store or shared by many stores and locations. The DSPT 100 can also work in conjunction with known scheduling programs, which track contact and other information about employees, allow a manager to create an initial schedule including at least which employees will be located where within the restaurant and for how long, allow for communication with employees, provide for the handling of emergencies, check employees' availability, and let employees know their schedule as soon it is posted, among other functions. The ISP can also include a forecasting application (separate from the DSPT 100 and scheduling application, or built into such applications), which can be used to forecast at least product demand and employee needs at the various stations/areas well in advance of a shift, based on historical data. In particular, when a manager is preparing an initial schedule for a shift, the forecasting application references and utilizes various historical data to determine the initial product demand and employee needs for a shift. The historical data that is used can directly include the number of employees, sandwiches, fries, drinks, desserts, etc that were used per shift for each area/station on the same or similar date and time in the past year or years, or can calculate the number of employees per station/area from other historical data, such as transaction counts (TCs), sandwiches per order, fries per order, drinks per order, total items per order, drive through transactions as a percent of total orders, etc., on the same or similar date and time in the past year or years. The manager can then more easily create initial shift schedules and assign employees to such shifts utilizing this projection application and the scheduler application, which will form a starting point for DSPT 100 to be utilized.

DSPT 100 may reside on a restaurant's local computer system and may use actual and projected customer demand at the restaurant based on, for example, sales data, transaction data, and product mix data, to determine, for example, the number of employees to assign to a given shift as well as the best place to position each person during each time increment throughout a shift. DSPT 100 may alternatively reside on a private network server or on an Internet server and may be operable remotely by a user using an Internet connection. DSPT 100 may optionally be configured as a web-based application accessible by a user over the Internet. Data upon which DSPT 100 operates, including restaurant-specific data corresponding to, for example, restaurant configuration and historical transaction data of that restaurant, and output data resulting from the operation of DSPT 100, may reside locally on restaurant computer systems, on a central or distributed database accessible over the Internet or a private network, or both. Updates of such data may be delivered or received by the restaurant over the Internet or private network in real-time to provide the most current source upon which DSPT 100 operates. Communication of any such data to and from the restaurant may also be achieved through wireless communication protocols, including those suitable for communicating using cellular telephone or satellite systems.

DSPT 100 may be configured to generate a report comprising, for example; a Dynamic Shift Positioning Guide (DSPG) 101 from the information that a shift manager provides and enters into DSPT 100. DSPG 101 may be configured to provide a shift manager:
How many crew members the shift manager needs at a predetermined number of work areas or crew member positions of the restaurant for each hour or other predetermined time increment of a shift, and the total overall number of crew members needed during each time increment of the shift. The predetermined number of work areas or positions of the restaurant may include, for example, one or more Drive-thru areas, the Front Counter area, the French Fry machine area, the Kitchen area including the Grill area, and the Beverage Center area, among others, and may vary according to actual restaurant configuration and layout.
Where to position and the sequence of positioning each employee assigned to a given shift per hour or other time increment to enhance productivity and efficiency, even in instances when the shift manager is predicted to be understaffed. The positioning of each employee may be determined by DSPT 100 in a sequential order to best satisfy a predicted customer demand. DSPT 100 may also identify the last position assigned, and at least two additional employee positions for assignment to one or more additional employees should predicted demand exceed actual demand.
What secondary duties should be assigned and to which employees in the event one or more employees have additional work capacity.
A prediction of the restaurant's sales and guest counts for each hour or other time increment of a particular shift.
Any other information suitable for assisting a Shift Manager to manage a particular shift more effectively.

In one implementation, to determine the number of employees a shift manager is predicted to need for each time increment of a given shift and where to best position them during each time increment of the shift, DSPT 100 uses historical data pertaining to a particular restaurant among a group of restaurants that is updatable in real-time. For each time increment, the historical data may include:
1. Number of Drive-Thru transactions and percent of the total number of transactions
2. Number of Front Counter transactions and percent of the total number of transactions
3. Average total number of items per transaction
4. Number of sandwiches per transaction
5. Number of units of french fries per transaction
6. Number of beverage units per transaction
7. Number and identification of different products on the menu
8. Number of delivery transactions and percent of the total number of transactions
9. Number of satellite transactions and percent of the total number of transactions
10. Number of particular types of sandwiches per transaction

For ease of reference hereinafter, these inputs may be called “Key Inputs” without attributing any particular meaning thereto. One of ordinary skill would appreciate that a greater or fewer number of inputs or different inputs may be employed without departing from the scope of the invention.

An implementation of DSPT 100 further comprises use of a Variable Labor Hour (VLH) Table for a particular restaurant among a group of restaurants, which provides the cutoff for the number of crew needed in each work area based on the above input, while taking the following considerations into account any number of variables, including:
1. Drive-Thru Type or Restaurant Type, such as Single Booth, 2-Booth Speaker, 3 both Face-To-Face, Dual Lane/Side by Side, Tandem In-Line, Non-Drive-Thru
2. Day part (breakfast, lunch, afternoon/snack, dinner, or after dinner)
3. Beverage service configuration, such as Crew Pour or customer Self Serve
4. Reference Item per Transaction for the day part
5. Restaurant Area (Kitchen, Drive Thru, Front Counter, Delivery, Dessert Kiosk, and others)

The VLH Table is useful in establishing a reference or standard minimum and maximum transaction through-put for each labor hour increment per work area. Demand exceeding the transaction through-put for any particular labor hour increment will necessarily require at least one additional labor hour to fulfill that demand, and therefore establish the cutoff for the number of crew needed at each work area for a given demand.

An implementation of DSPT 100 further comprises use of restaurant-specific configuration and layout data stored in one or more reference tables. The parameters by which the restaurant configuration may be defined includes:
1. Restaurant or Drive-Thru Type, such as Single Booth, 2-Booth Speaker, 3 both Face-To-Face, Dual Lane/Side by Side, Tandem In-Line, Non-Drive-Thru
2. Day part (breakfast, lunch, or dinner), including a definition of the specific hours of the day that each menu item is available to be served
3. Number of sales registers at the Drive-Thru and at the Front Counter
4. Equipment amount, configuration and location, including: number and location of fryers for fried products; configuration of the kitchen including number and location of grills, and definition of the configuration and operating schedule of the equipment pertaining to each day part
5. Beverage service configuration, such as Crew Pour or customer Self Serve

Additional reference tables may be used to dynamically determine primary crew positions, secondary duties and multiple levels or work areas of responsibility for each employee. The placement or assignment of each employee to one or more positions or work areas may be graphically displayed as an overlay on a graphical layout of the restaurant. The parameters by which these details may vary includes:
1. Restaurant or Drive-Thru Type
2. Day part
3. Number of Sales Registers
4. Restaurant Position or Work Area
5. Total number of employees per Position or Work Area

For example, if there are a total of two people assigned to the Drive-Thru window area, then a first assigned person will have primary duty as “Order Taker/Cash” and a second assigned person will have the primary duty as “Runner.” If, for example, three people have been assigned to the Drive-Thru window area to meet a predicted demand, then the primary duty titles for each employee would be “Order Taker,” “Cashier,” and “Runner,” respectively. One of ordinary skill would appreciate that the data inputs to DSPT 100 may vary according to the restaurant configuration as well as the country in which the restaurant operates.

An implementation of DSPT 100 may comprise receiving and/or inputting the following data to determine an optimum employee positioning guide, such as DSPG 101 for use by restaurant managers: (1) restaurant layout information corresponding to a particular restaurant among a group of restaurants describing the physical location of each work area relative to one another, (2) VLH reference information to establish employee transaction capability, and (3) historical customer demand data corresponding to the particular restaurant, comprising: (i) the number of transactions per time increment, (ii) the number of sandwiches per Transaction or Order, (iii) the number of fries per Transaction, (iv) the number of beverages per Transaction, (v) the average number of items per Transaction, (vi) the Drive-Thru transaction percent of the total number of transactions obtained through a combination of Drive-Thru transactions and Front Counter transactions, and (vii) the number and identification of different products on a particular restaurant's menu for each time increment. A fewer or greater number of historical customer demand data may be utilized without departing from the scope of the invention.

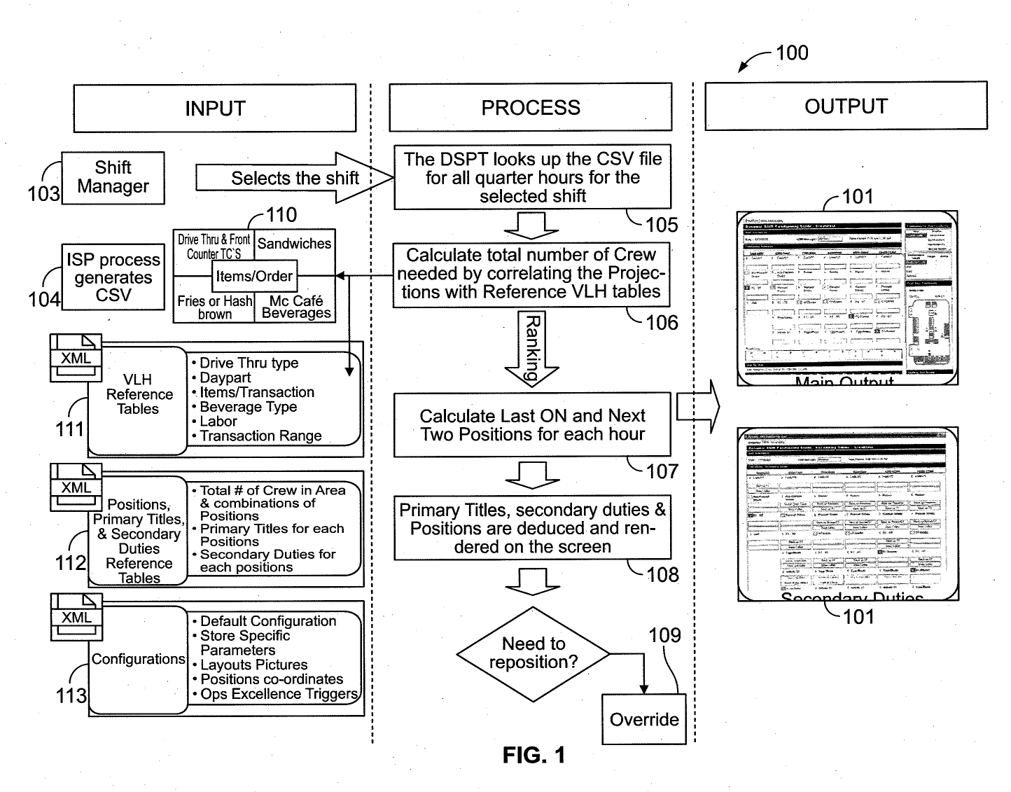

Turning now to the figures, FIG. 1 shows an exemplary embodiment illustrating an overall flow diagram of a process by which DSPT 100 produces DSPG 101. At step 103, a shift manager selects a shift on a particular day of a year, which can be done in combination with and with inputs from the scheduling program, such as the initial schedule including each position and assigned staff for each position that has been previously entered by a manager, described herein above. At step 104, the ISP generates a CSV file based on the Key Inputs 110, also described above. At step 105, DSPT 100 looks up the CSV file for all quarter hours for the selected shift and calculates a total number of crew members needed by correlating the predicted demand against the reference VLH tables 111, 112, and 113 for that restaurant. At step 106, each Position predicted to be needed is sequentially ranked according to the order of need by position to form a staffing positioning sequence. For example, if 5 employees are needed to meet a predicted customer demand over a particular time increment, each may be sequentially assigned to a particular position or work area of the restaurant, such as Drive-Thru, Grill, Front Counter, and the like, according to the algorithm set forth in DSPT 100. The sequence of employee positions may be displayed in a computer display or any other output device, or printed by a printer to obtain a hard copy if desired.

At step 107, DSPT 100 determines the Last On employee and respective position assigned to that employee. DSPT 100 additionally determines the Next Two positions to be assigned to the next two employees needed if actual demand exceeds predicted demand. At step 108 DSPT 100 determines and keeps track of each position's primary title for each position, secondary duties that may be assigned if capacity permits, and displays this information in a computer display or hard copy output, as the case may be.

At step 109, DSPT 100 permits a shift manager to manually adjust any result of the DSPT 100, such as the number of employees needed, to account for unforeseen circumstances, employee call offs, customer demand and the like. Similarly, a shift manager may manually adjust one or more inputs to DSPT 100, such as the projected demand, to obtain the number of employees needed and the positions or work stations for each to be assigned.

For accurate scheduling and positioning of employees in a fast food restaurant, it may be useful to have updated staffing reference tables and the correct VLH settings in each restaurant's ISP and DSPT 100. In the U.S. and elsewhere, most tables and settings may be automatically pushed to the restaurants' ISP from a central server.

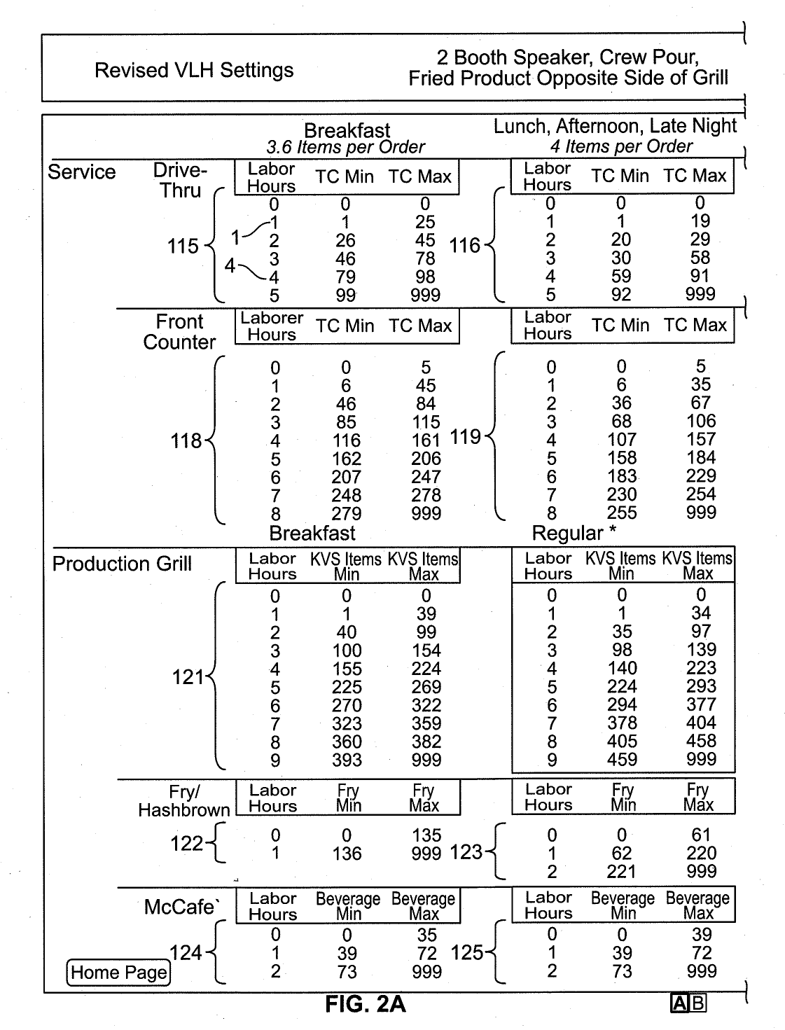

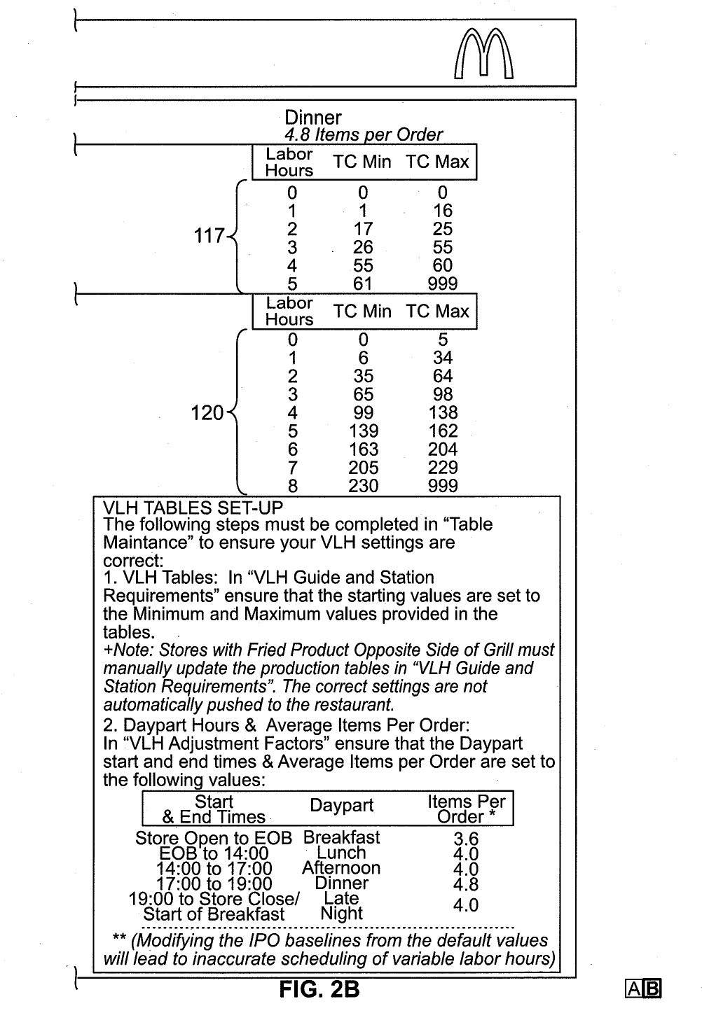

As noted previously, the tables that apply to a specific restaurant will be dependent on restaurant configuration, such as Drive-Thru Type, Front Counter Beverage system, and the like. FIG. 2 illustrates an exemplary collection of standard reference tables for a restaurant having a 2-Booth Speaker Drive-Thru setup, a Crew Pour beverage center setup, with Fried Product Fryers located on the opposite side of the grill. The tables identify the staffing cutoffs for each work area of the restaurant during each day part, such as breakfast, lunch and dinner. For labor hours 0 to integer “x,” the minimum and maximum Transaction Count (TC) for the corresponding labor hours is shown for each of breakfast, lunch, and dinner according to each work area of the restaurant.

More particularly, for a historical average of 3.6 items per Transaction on the selected day of the year for a particular restaurant, the VLH table 115 of FIG. 2 at row 1 indicates that an employee should be capable of fulfilling from 1 to 25 transactions per hour. By contrast, the VLH table 115 of FIG. 2 at row 4 indicates that 4 employees should be capable of fulfilling from 79 to 98 transactions per hour assuming an average of 3.6 items per Transaction.

In general, for each day part, the VLH tables 115-121 of FIG. 2 shows that as the number of items per transaction increases, the VLH tables 115-121 of FIG. 2 indicate that the number of transactions for a given labor hour decreases for each position or work area. This is due to the simple fact that as the number of parts to a transaction increases, the capability to fulfill a given number of transactions per hour decreases for employees at these positions or work areas.

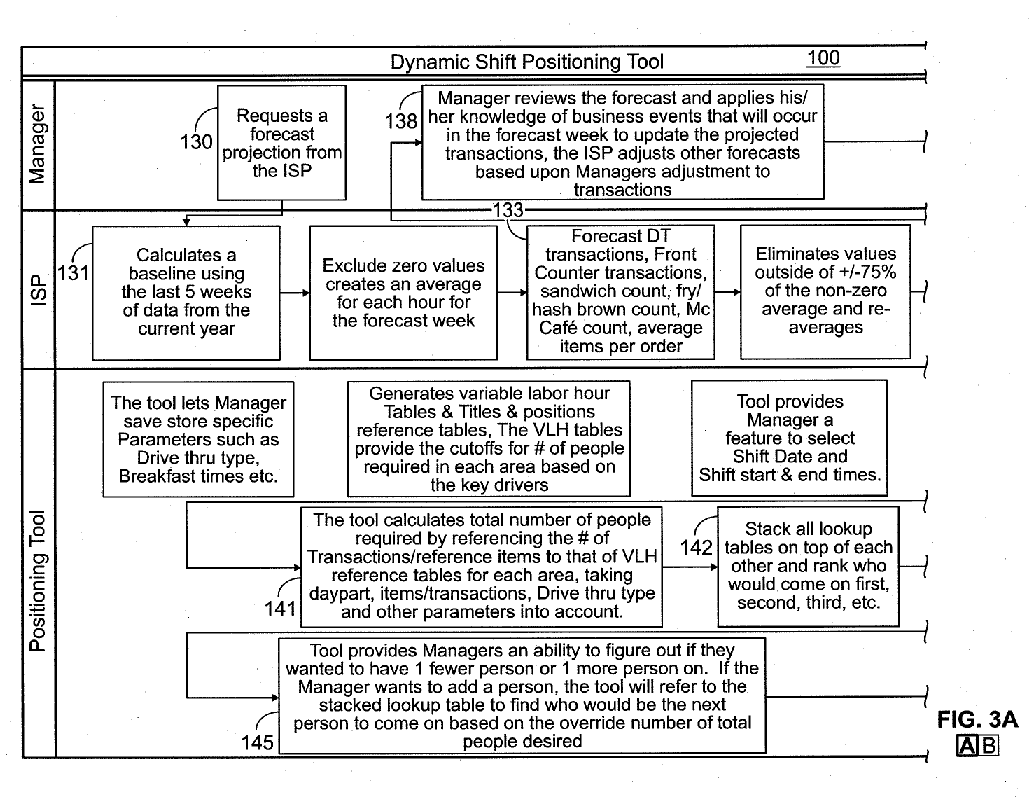

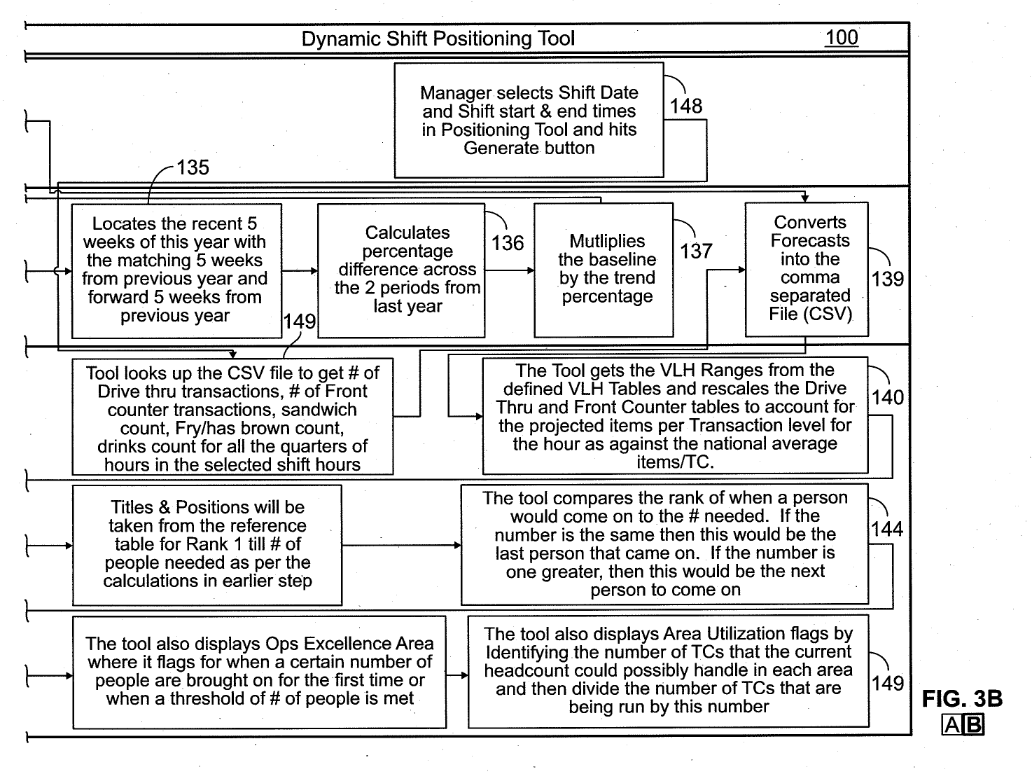

Turning now to FIG. 3, there is shown a detailed flow diagram of an exemplary DSPT 100. At step 130, a shift manager requests a forecast projection from the ISP. The ISP at step 131 calculates a baseline projection using, for example, the last five weeks of data from the current year. At step 133, the ISP forecasts the number of Drive Thru transactions, the number of Front Counter transactions, the sandwich count, fry/hashbrown count, beverage count, and average number of items per transaction. At step 135, the ISP locates the recent five weeks of the current year with the matching five weeks from the prior year and the forward five weeks from the prior year, and at step 136, calculates the percentage difference across the two periods from the prior year. At step 137, the ISP multiplies the baseline projection by the trend percentage.

At step 138, the shift manager reviews the forecast and applies his or her knowledge of current business events believed to occur in the forecast shift or shifts to update the projected transactions. The ISP may then adjust other forecasts based upon the shift manager's adjustment to the forecasted demand. The ISP, at step 139, then converts the forecasts into a comma separated value (“CSV”) for use by the DSPT 100.

At step 140, DSPT 100 obtains the VLH employee capacity ranges from the defined VLH Tables, and adjusts the Drive Thru and Front Counter tables to account for the projected items per transaction for the time increment as against a national average of the number of items per transaction for the same time increment. At step 141, DSPT 100 calculates a total number of employees required for the forecasted shift or shifts, and at step 142 ranks or sequences each employee to each work area in the order in which each employee should be added to the crew for a given forecasted shift or shifts.

At step 144, DSPT 100 determines the rank or sequence of when a person would be added to a particular position as compared to the total number of crew positions needed. If the number is the same, then DSPT 100 would identify the last person assigned to the crew. If the number is 1 person greater, then this would be the next position to be assigned to the crew should it become necessary to meet a sudden rise in demand.

At step 145, DSPT 100 provides information to shift managers to determine whether one fewer person is available or one additional person is needed for a forecasted shift or shifts. The tool then provides the manager with the adjusted sequence of crew positions based on his or her input. At step 147, DSPT 100 may also display restaurant area utilization information by identifying the number of transactions that the current headcount is fulfilling per time increment and dividing that by the number of transactions that the current headcount can possibly fulfill in each work area over the same time increment.

### Determination of Number of Employees (Head Counts) Needed

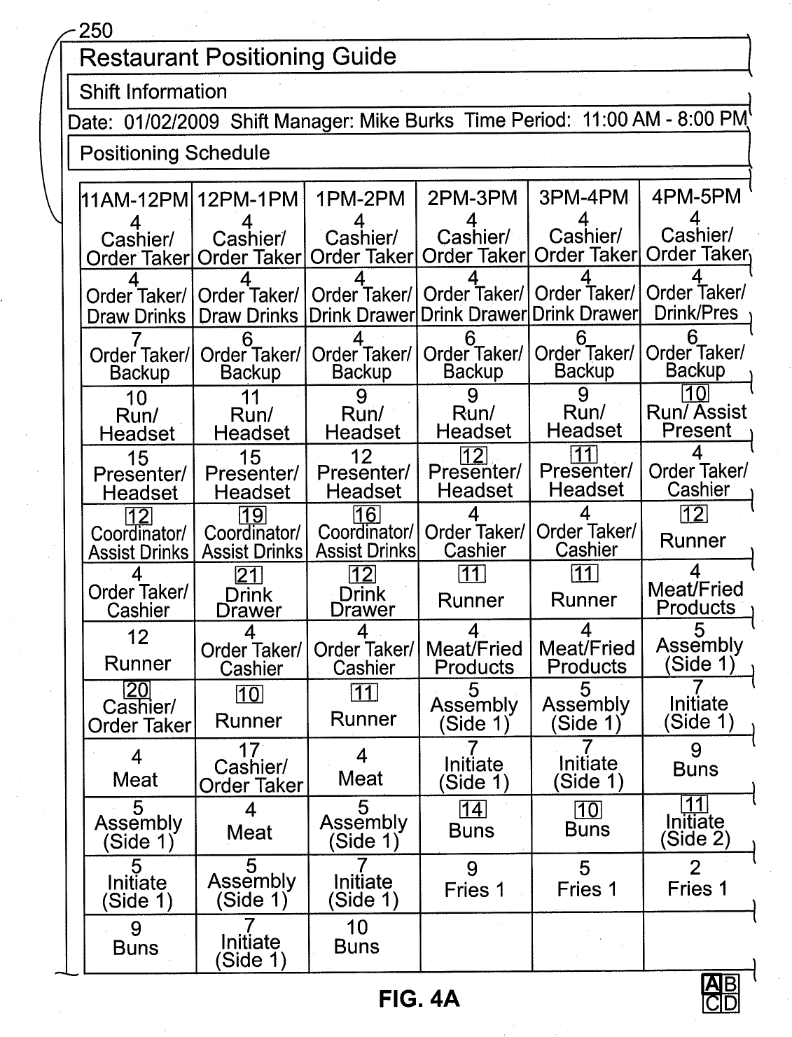

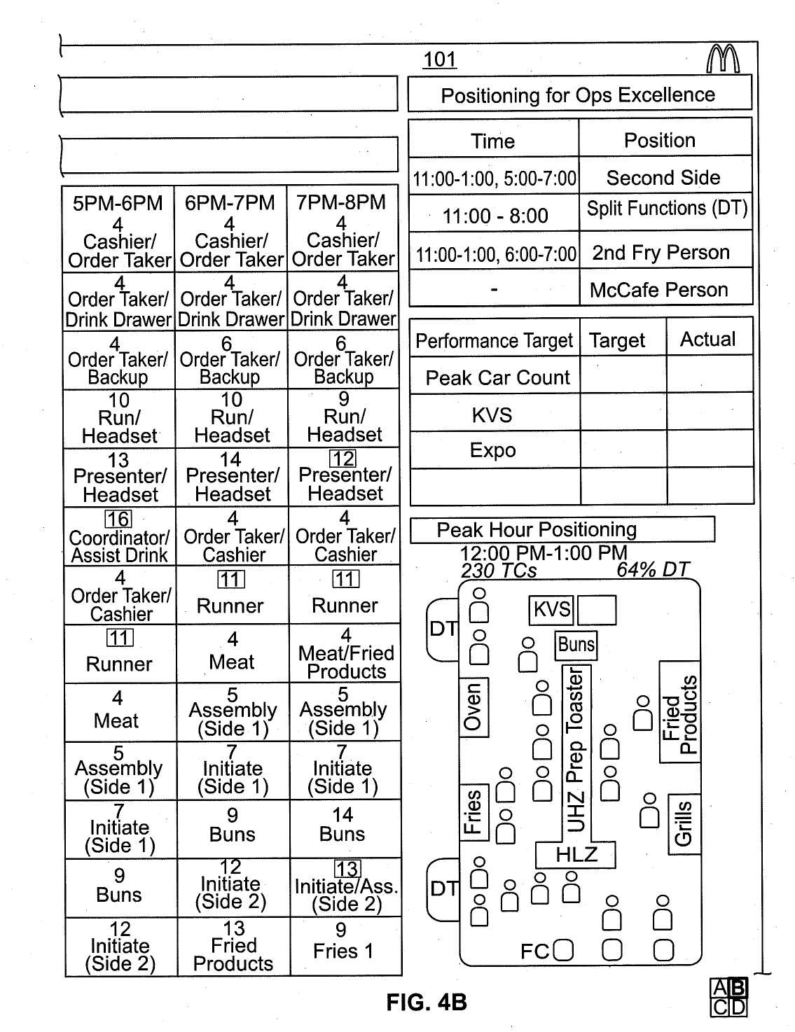

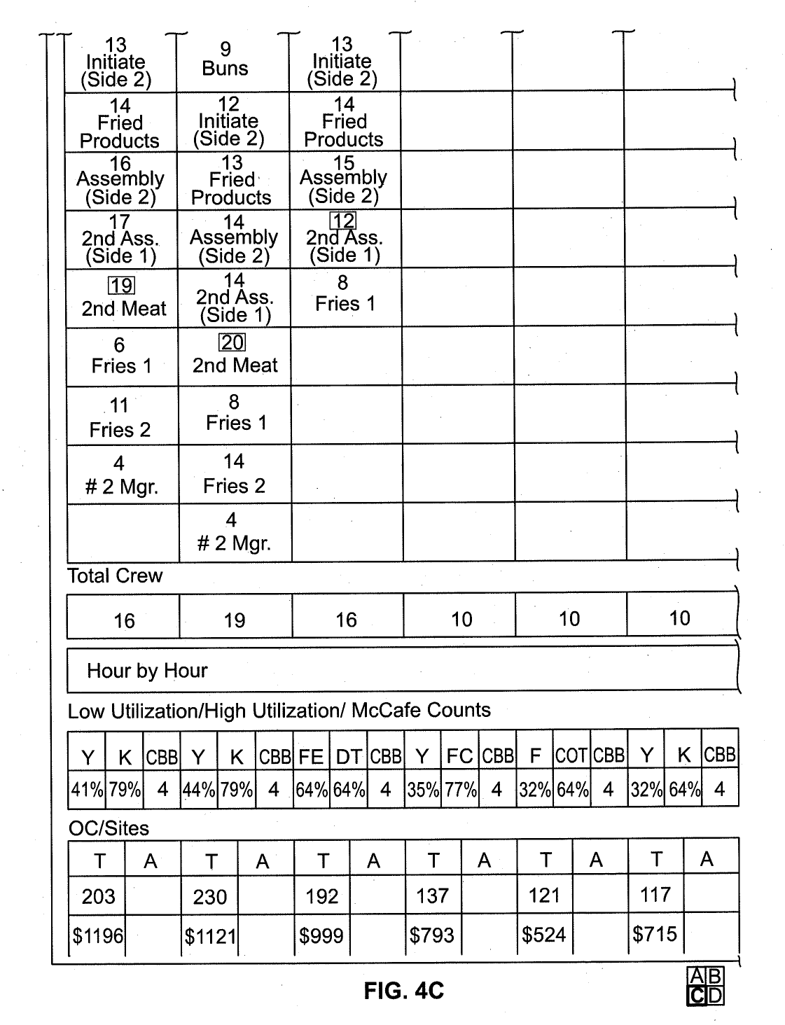

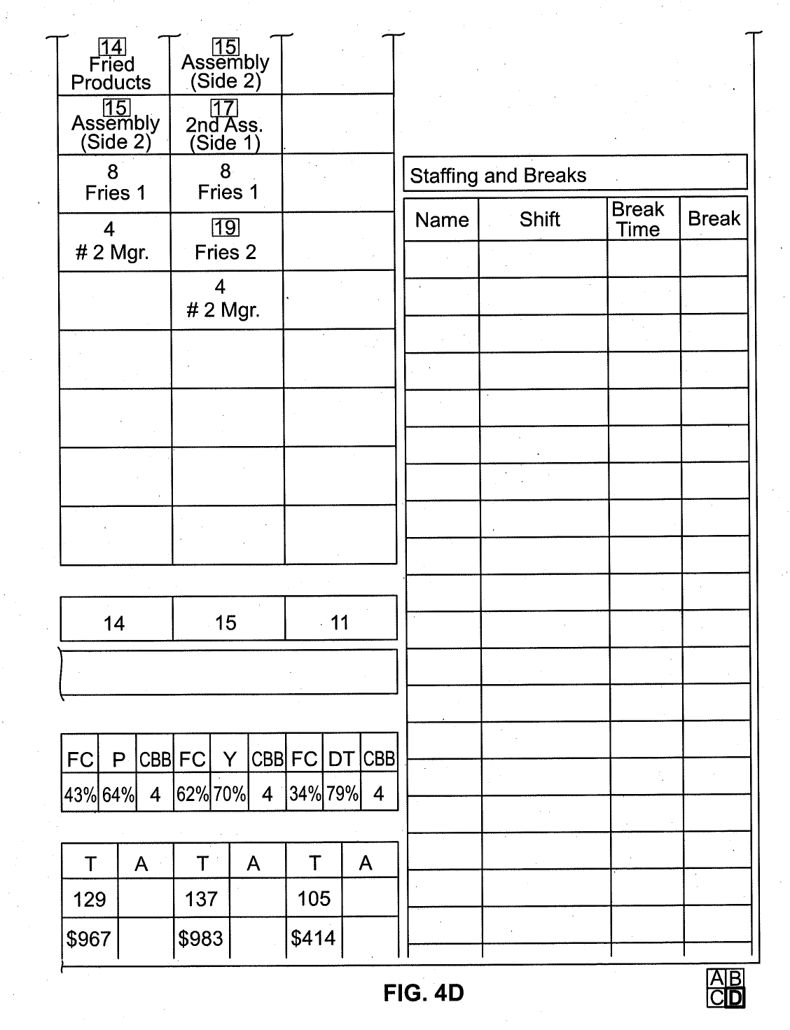

Turning now to FIG. 4, the steps to arrive at specific employee head counts needed for any given work area per hour, as well as the total employee head count, are as follows. For the Front Counter position or work area, for example, the employee head count prediction is determined at step 150 by first obtaining the Average Number of Items per Transaction and calculating the projected Number of Front Counter Transactions, which is equal to the Total Number of Transactions (Volume) minus the Total Number of Transactions multiplied by the quantity (1 minus Drive-Thru %). At step 151, DSPT 100 then looks up on a VLH Table corresponding to the Front Counter the two closest matching transactions between which the number of Front Counter Transaction Count cut off values lie within the historical data while considering the Number of Items per Transaction, among others.

Once the two closest matching transactions and the corresponding employee head counts are determined, DSPT 100 calculates at step 152 the Front Counter Head Count required and the corresponding Transaction Count cut off. The Front Counter head count value is the number of employees associated with the looked up Transaction Count cut off value, which is just greater than the number of Front Counter Transaction Count cut offs.

An example for determining the Transaction Count cut off value is as follows. If 100 transactions in any particular hour were predicted, and the Drive Thru Percent is 60% of the total number of transactions fulfilled per time increment, then the projected Drive Thru Transactions would equal 60 and the Front Counter transactions would equal 40. Looking up the historical data on the VLH Table for 40 Front Counter transactions (while considering the Items per Transaction, etc.), the projected Front Counter employee head count may equal two because, for example, one Front Counter person can serve up to 32 transactions per time increment. If two people can serve from 33 to 60 transactions per hour, the Front Counter Transaction Count cut off value would equal 60 (i.e., the maximum number of transactions that two employees in this hypothetical can serve). In addition, in this example, “33” would be the value for the input variable “Number of Transactions That Last Person Came On.”

According to step 153, the next item to calculate is the Front Counter Transactions That Last Person Came On. Out of the two values looked up, this is the one which is less than the number of Front Counter Transaction Count cut offs.

The other positions or work areas of the restaurant, such as the number of persons needed to be assigned at the Drive Thru area, are computed as shown in each corresponding row of FIG. 4. In each case, the area-wise head count output by DSPT 100 may be color coded to assist shift managers when viewing DSPG 101.

The Transaction Count cut offs for all employee head counts per work area may then be adjusted into a Transaction Count cut off value that is the same for all transactions. Based on these adjusted Transaction Count cut offs, ranks may be given as to when a particular employee is scheduled to begin work, which may be reported for every time increment, such as every hour or quarter hour. This rank may be displayed in DSPG 101.

The VLH tables (such as those described above and as exemplarily shown in FIG. 5) for each of the positions or work areas in the restaurant, such as the Drive Thru, the Front Counter, Grill, Fry/Hash Brown, and specialty drink/food positions or work areas, provide the maximum number of transactions for a given time increment that a given number of employees can support assuming that the average items per transaction for the given time increment is equal to the national average for the respective day part for the same restaurant configuration in terms of geographical layout and equipment. Other tables including similar type information can also be created and used for beverage distribution areas, order assembly areas, a position of food production line areas of order delivery areas, dessert areas (such as dessert kiosks); and/or satellite locations for product distribution. In the United States, for example, the national average number of items per transaction during lunch may be 4.0. According to the VLH table shown in FIG. 5, the Drive Thru portion of the table indicates that 2 crew can support 13 to 45 Drive Thru transactions at 4.0 Items per transaction. If the restaurant's projected items per transaction for the given time increment is higher than 4.0, then the table's cutoffs will need to be adjusted for that restaurant to indicate that the crew can support fewer Transaction Counts. Similarly, if the restaurant's projected items per transaction for the time increment is lower than 4.0, then the table's cutoffs may need to be adjusted to indicate that the crew can support more Transaction Counts. To make an adjustment to the VLH tables for each respective restaurant among the group of restaurants, DSPT 100 may use the following formula:

Adjusted TC Max=TC Max*(Drive Thru TC %+(Front Counter TC %*(National Average Number of Items per TCs)/(Projected Number of Items per TCs)))

If, for example, the Drive Thru Transaction Counts per time increment equals 64 and the Front Counter Transaction Counts equals 45, using the above formula together with the VLH table of FIG. 5, an adjustment to the Drive Thru and Front Counter maximum Transaction Counts may be made, assuming a national average of 4.0 Transaction Counts and a projected item per transaction of 4.5. A summary of the results of these calculations reflecting such adjustments is shown in FIG. 6.

Using the adjusted VLH values shown in FIG. 6, DSPT 100 may determine the required number of crew members in the Drive Thru area by comparing the projected number of Drive Thru Transaction Counts to the Adjusted TC Min and TC Max in the Drive Thru staffing table of FIG. 6. In this example, 64 Drive Thru Transaction Counts lies between 61 and 87 in FIG. 6. Therefore, 4 Drive Thru crew are required for the time increment at issue.

Similarly, DSPT 100 may determine the required number of crew members in the Front Counter area by comparing the projected number of Front Counter Transaction Counts to the Adjusted TC Min and TC Max in the Front Counter staffing table. In this example, 45 Front Counter Transaction Counts lies between 42 and 81. Therefore, 2 Front Counter crew are required for the time increment at issue.

### Determination of Staffing Order

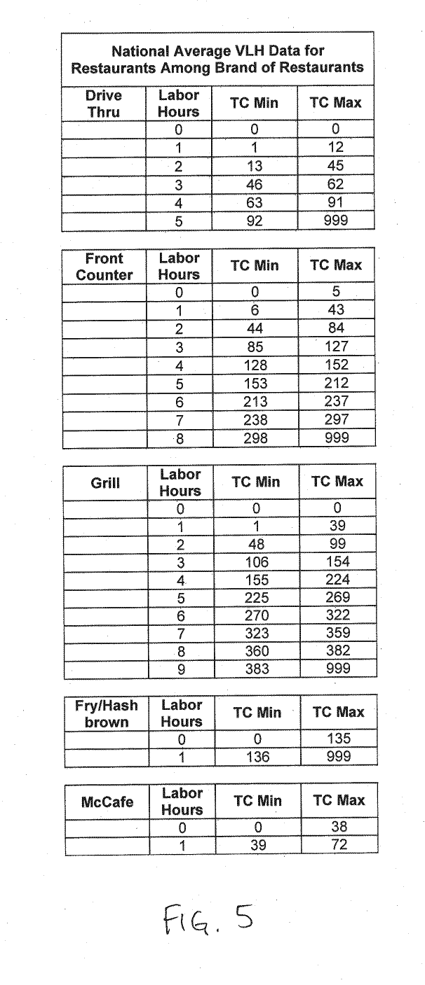

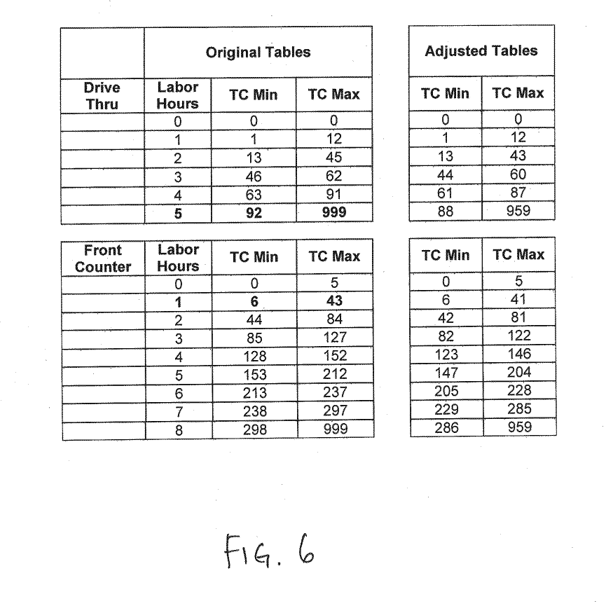

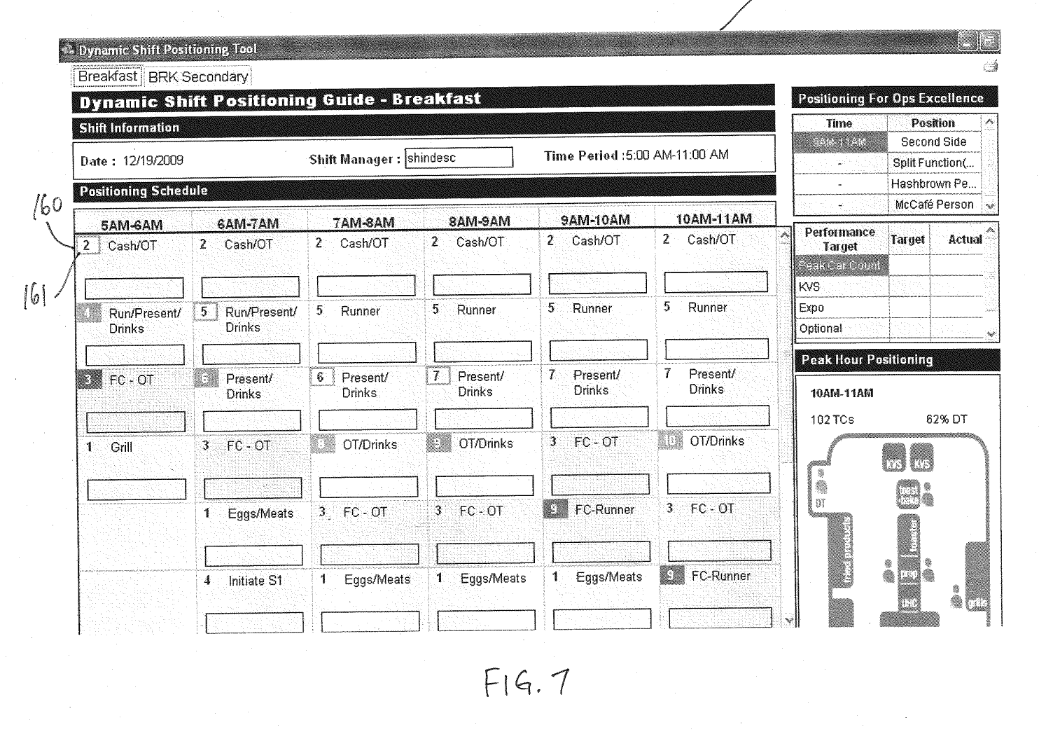

Turning to FIG. 7, DSPT 100 may identify the specific sequence in which crew members may be scheduled for each time increment of a shift based on the projected restaurant demand for that time increment. Numbers 161 in the top left corner of each position box 160 identify the sequence of when the identified crew position is scheduled for a given time increment in a given shift. This enables DSPT 100 to identify the crew person who was the last person to be assigned to the shift and the next two people that may yet be assigned to the shift if actual transaction volumes are higher than predicted.

In an embodiment, to identify the staffing sequence of each employee position, DSPT 100 may modify the VLH tables so that they are all on the same scale. Drive Thru Labor may be projected on Drive Thru TCs, Front Counter Labor may be projected on FC TCs, Grill Labor may be projected on Sandwich counts, French Fry labor may be projected on French Fry count, Beverage Center labor may be projected on beverage counts. An adjustment factor can be used to do so, as follows:

Adjustment Factor=VLH Base Item per Order/Projected Number of Items per TCs

DSPT 100 may further modify the Staffing Minimums and Staffing Maximums for the Front Counter, Drive Thru, Grill, Fry, and Hashbrown portions of the VLH tables so that they are all based on Total Transaction Counts. This may be done by:
1. Calculating the average Sandwich, French Fry, and Beverage units per Transaction. In one example, if there are 109 total projected TCs, 218 projected Sandwiches, 120 projected French Fries, and 24 projected Beverage units, the average Sandwich, French Fry, and Beverage units per Transaction would be:

218 projected Sandwiches/109 Projected TCs=2 Average Sandwiches per Transaction

120 projected French Fry units/109 Projected TCs=1.1 Average French Fries per Transaction

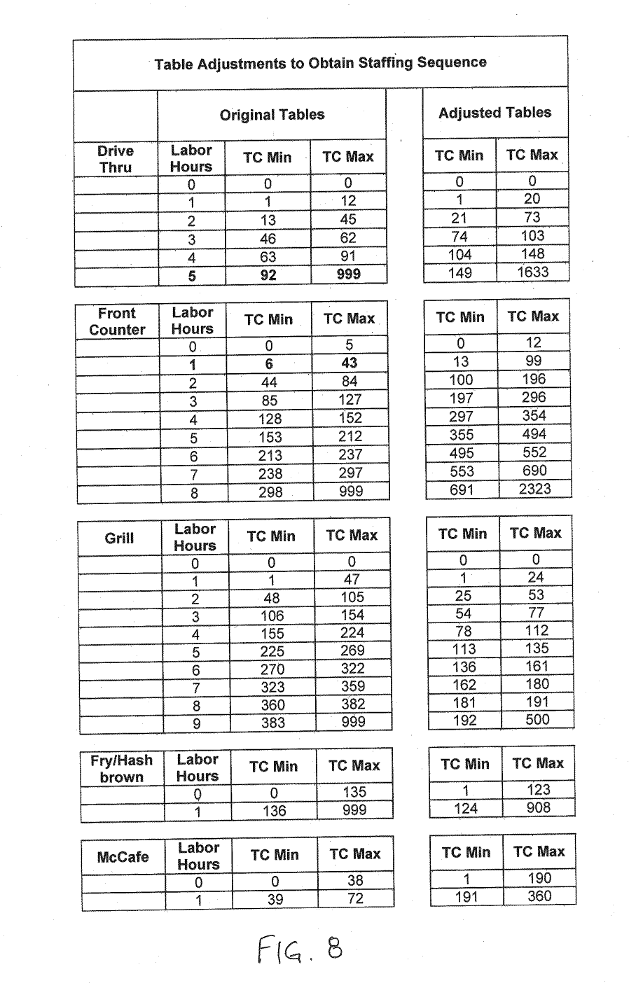

24 projected Beverages/109 Projected TCs=0.2 Average Beverages per Transaction
2. Using the appropriate average units per transaction to modify the Staffing Minimums and Staffing Maximums for the Grill, French Fry, and Beverage Center areas. This may be done by dividing the Maximums in each table by the appropriate average units. These computations would result in the adjustments shown in FIG. 8. Adjusted TC Minimums are set to 1+ the adjusted TC Maximums for the previous staffing level.
3. Using the Drive Thru percent to modify the TC Minimums and TC Maximums for the Front Counter and Drive Thru. This may be done slightly differently for the Front Counter and Drive Thru:
   For Drive Thru: Divide the TC Maximums by the Drive Thru percent
   For Front Counter: Divide the TC Maximums by (1 minus the Drive Thru percent)
   Adjusted TC Minimums are set to 1+ the adjusted TC Maximums for the previous staffing level

Adjustments now include:
1. Number of Items per Transaction adjustment applied to Drive Thru and Front Counter TC Min and TC Max.
2. Drive Thru and Front Counter TC Min and TC Max adjusted to Total Transaction Counts.
3. Grill, French Fry, Beverage Center Staffing Minimum and Maximums are converted to Total Transaction Counts.

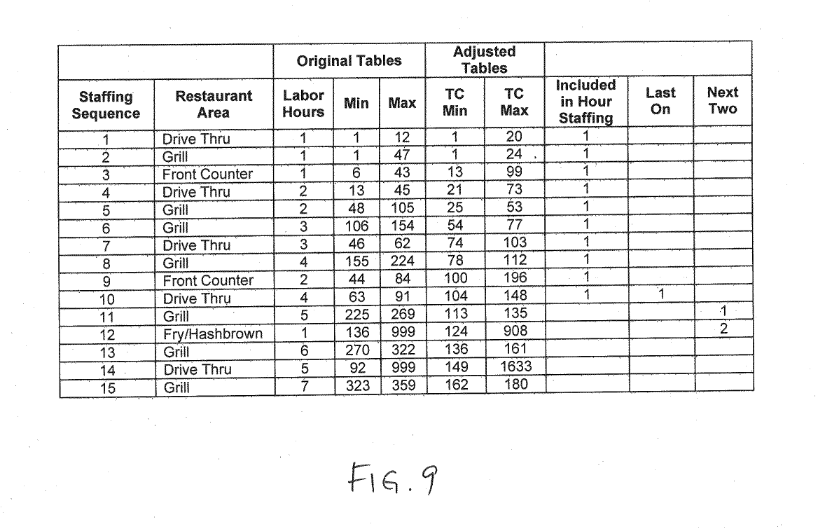

Once all tables have been adjusted, all tables are combined and the positions are sorted according to the Adjusted TC Minimum. The resulting table for the above example is provided in FIG. 9, which indicates that the Drive Thru position is the first person assigned to the shift, the Grill position is the second person assigned to the shift, the Front Counter position is the third, and so on as indicated.

According to FIG. 9, DSPT 100 may determine and report on DSPG 101 the last person scheduled for the shift as the 4th Drive Thru person, and the next two people that would be scheduled if actual Transaction Counts increased beyond the projected capacity of the assigned personnel as the 5th Grill person and the 1st Fry/Hashbrown person:

### Determination of Employee Utilization

To determine which position or work area of the restaurant is the most and the least utilized for any desired time increment, DSPT 100 may first identify the last position that was assigned to the shift in each position or work area using the table of all positions that was sorted by the Adjusted TC Minimum, as shown in FIG. 9. DSPT 100 may then compute the utilization of the crew in each area using the following formula for the respective labor hours required:

(Projected Transaction Counts/Staffing Max)*100

By way of example, assuming 218 sandwiches, 45 Front Counter Transaction Counts, and 64 Drive Thru Transaction Counts are actually fulfilled for a given time increment, the utilization percent for the last three employees assigned to the shift could be computed by DSPT 100 by taking the actual Transaction Counts for each work area and dividing that number by the VLH maximum for the required head count (adjusted for the predicted Number of Items per Transaction for the Front Counter and the Drive Thru):

Grill:

218 actual TCs/224 Grill TCs max (from FIG. 9 for 4 labor hours)=97%

Front Counter:

45 actual TCs/81 Front Counter Adjusted TCs max (from FIG. 8 for 2 labor hours)=56%

Drive Thru:

64 actual TCs/87 Drive Thru adjusted TCs mas (from FIG. 8 for 4 labor hours)=74%

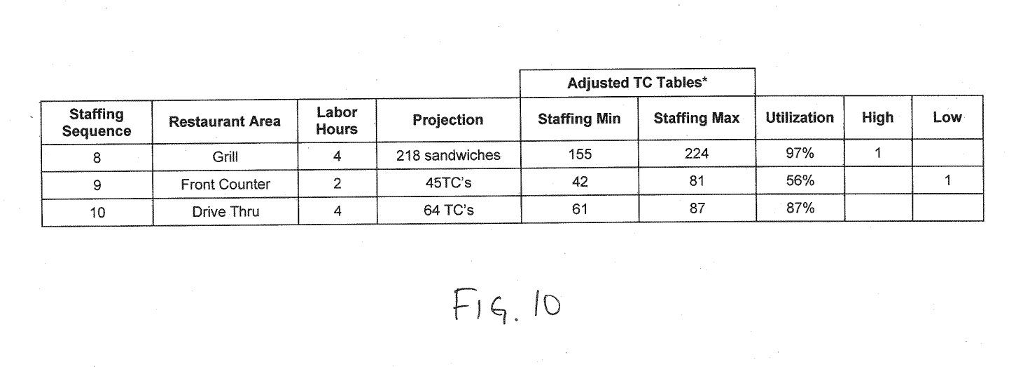

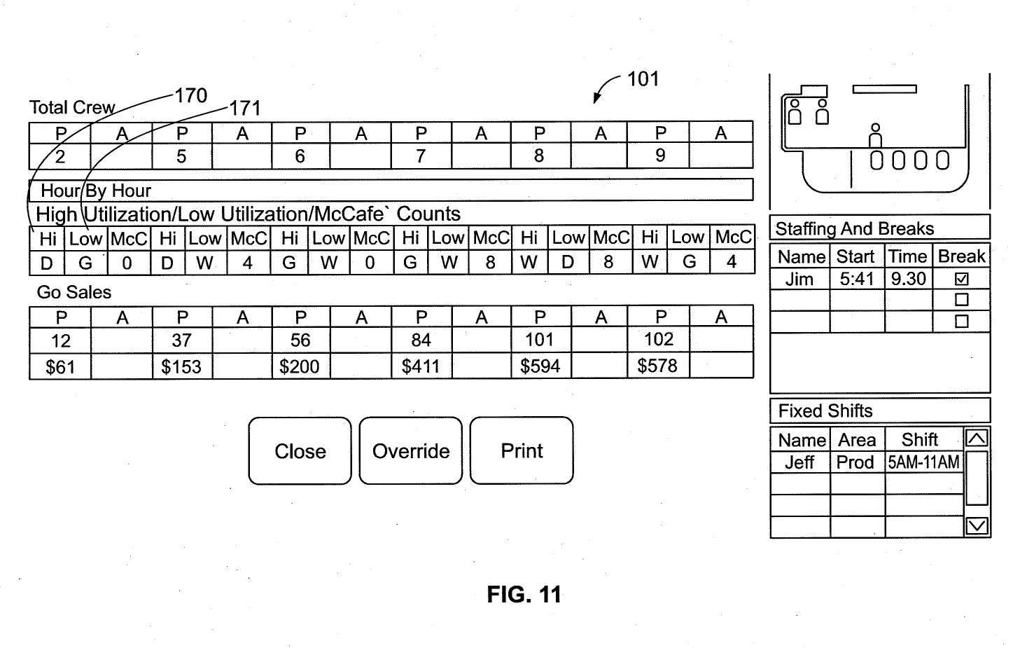

The result of these computations is shown in FIG. 10. As further shown in FIG. 11 reflecting a portion of DSPG 101, the area with the highest percentage may be flagged, such as by color coding, as the most utilized (see item 170) and the least utilized (see item 171), respectively. DSPG 101 may also identify the highest and lowest utilized work areas for each time increment of a given shift. In this way, the shift manager can quickly and easily identify trends that are developing or occurring in a shift and help or reassign employees to secondary duties or, alternatively, reassign the employees from secondary duties to their primary duties, to quickly adapt to changes in customer demand.

Turning now to FIG. 12, there is shown an exemplary graphical user input (GUI) 200 for users of DSPT 100. GUI 200 includes shift set up options 204, restaurant primary configuration options 210, restaurant secondary duty configuration options 220, equipment configuration options 230, breakfast configuration options 240, and performance target configuration options 245.

For shift setup options 204, a user, such as a shift manager, may select a shift date, and a start time and an end time for a shift occurring on the selected date. The user may select from either a 24 hour time format or a 12 hour time format. Each of these selections may be performed using pre-populated drop-down boxes, for example, the data for which being stored in one or more XML files, for example.

For restaurant primary configuration options 210, a user may select, and therefore configure, restaurant type 213 that best pertains to the configuration of the restaurant at issue. To describe whether the restaurant has a Drive Thru, and if so, the configuration of that Drive Thru, a user may select from among a drop down list of configuration items, including Single Booth, 2 Booth Speaker, 3 Booth Face To Face, Dual Lane/Side-By-Side, Tandem In line, Remote Wireless Order Taking, or Non-Drive Thru. The user may also be able to select a number of front counter registers that pertain to the restaurant using drop down 214.

For equipment configuration options 230, a user may select the number of grills in use at the restaurant from drop down 232, as well as the configuration of the front counter beverage service from drop down 234. Drop down 234 may include Crew Pour or self Serve options, for example. Equipment configuration option 230 may also permit a user to select the location of fried product fryers. For example, drop down 136 may provide the option of selecting the location of the fryers either on the same wall as the grills or on the opposite wall as the grills. One of ordinary skill would appreciate that any number of configuration options may be pre-programmed and available for a user to select depending, on the configuration and characteristics of the particular restaurant.

Breakfast configuration options 240 may include user selectable days and times for the start and end of service of items available under the restaurant's breakfast menu. Other configuration options could added as well, such as for layout, quantity, and/or position of beverage distribution areas; a layout, quantity, and/or position of order assembly areas; a layout, quantity, and/or position of food production line areas; a layout, quantity, and/or position of order delivery areas; a layout, quantity, and/or position of dessert areas (such as dessert kiosks); and/or a quantity and/or position of satellite locations for product distribution, some of all of which could be a part of other types of restaurant configurations.

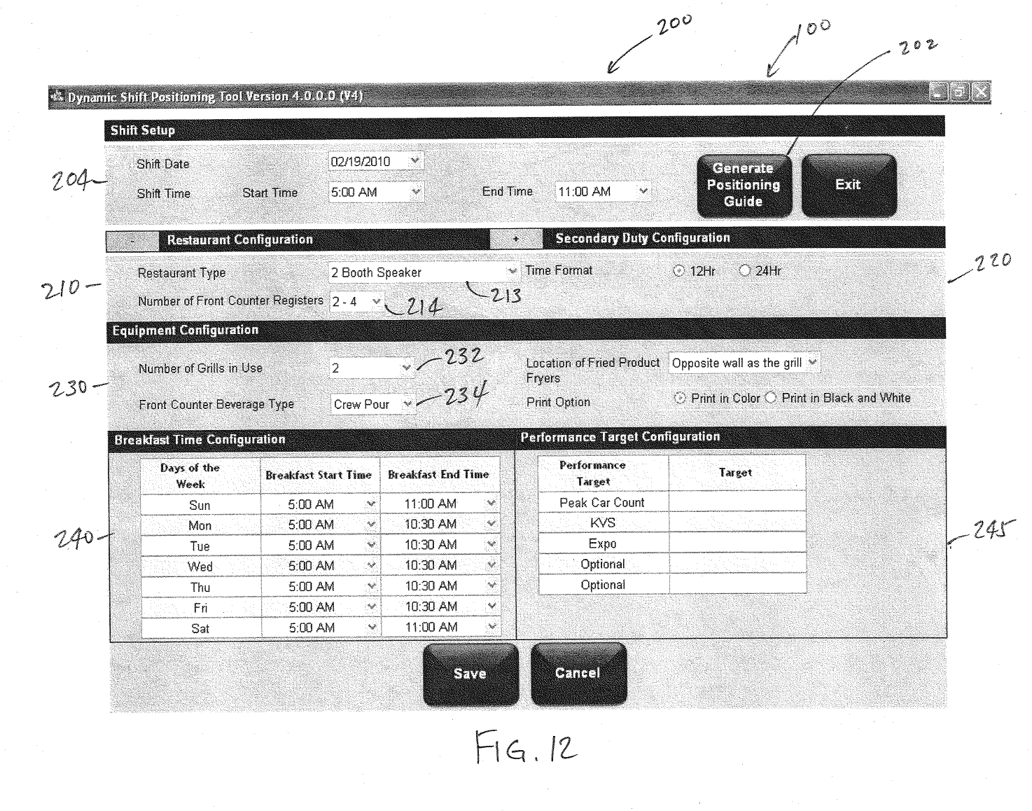

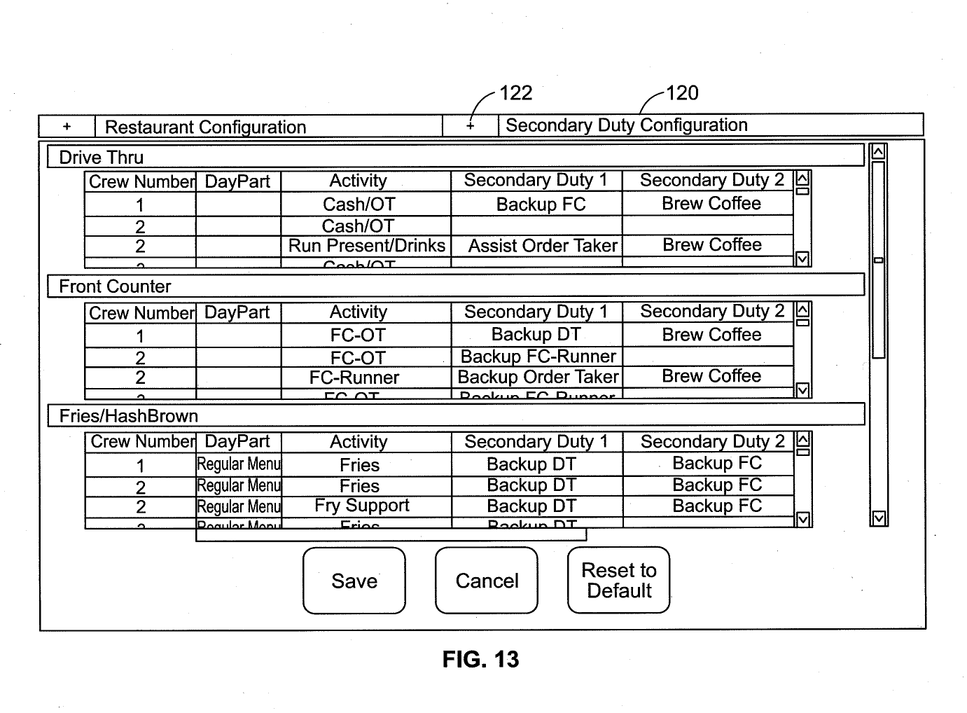

Turning now to FIG. 13, there is shown various secondary duty configuration options. If a user were to select button 122. As shown, secondary duty configuration options may include secondary duty options for the drive thru, the front counter, and the fries/hash brown work areas if customer demand permits reassignment of employees to one or more secondary duties.

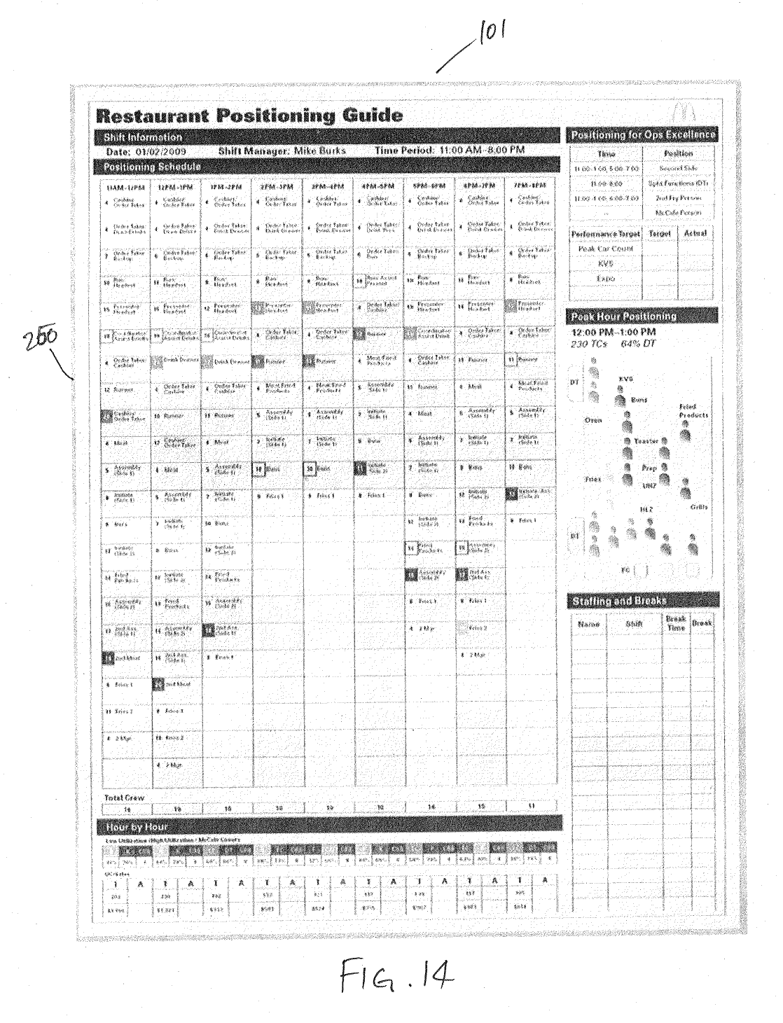

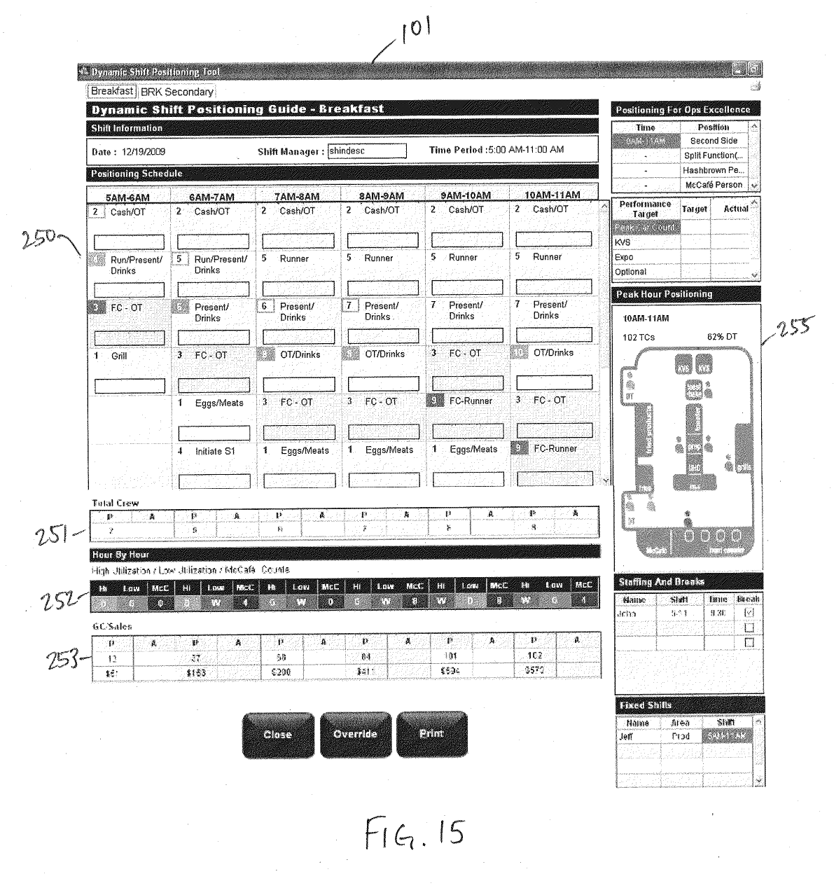

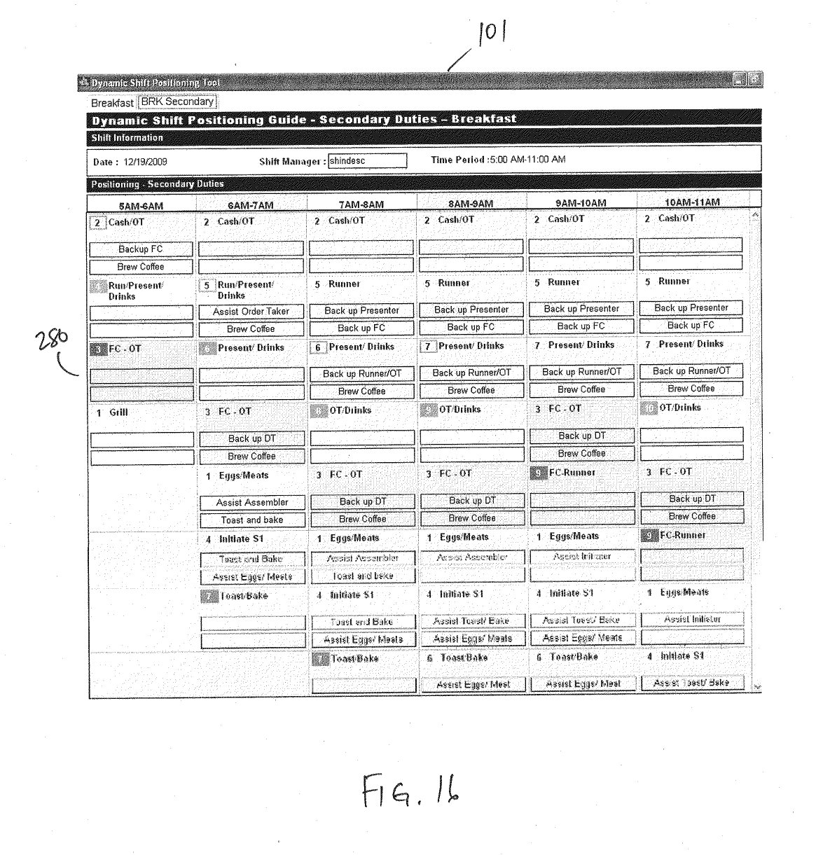

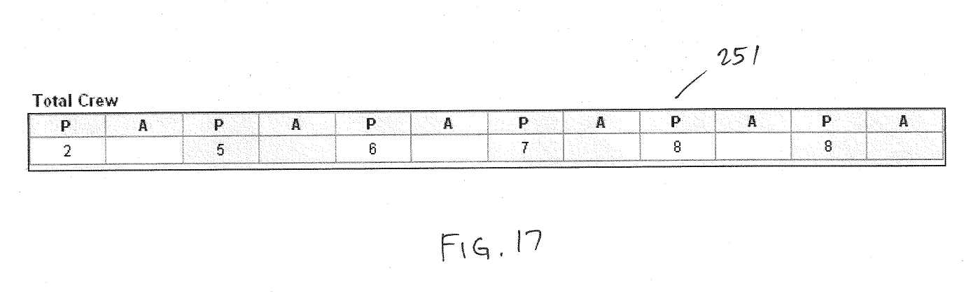

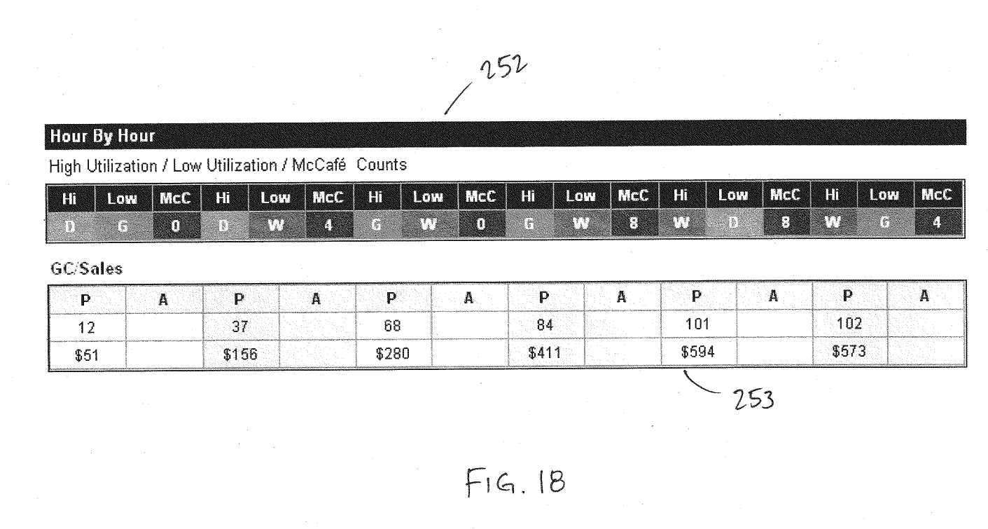

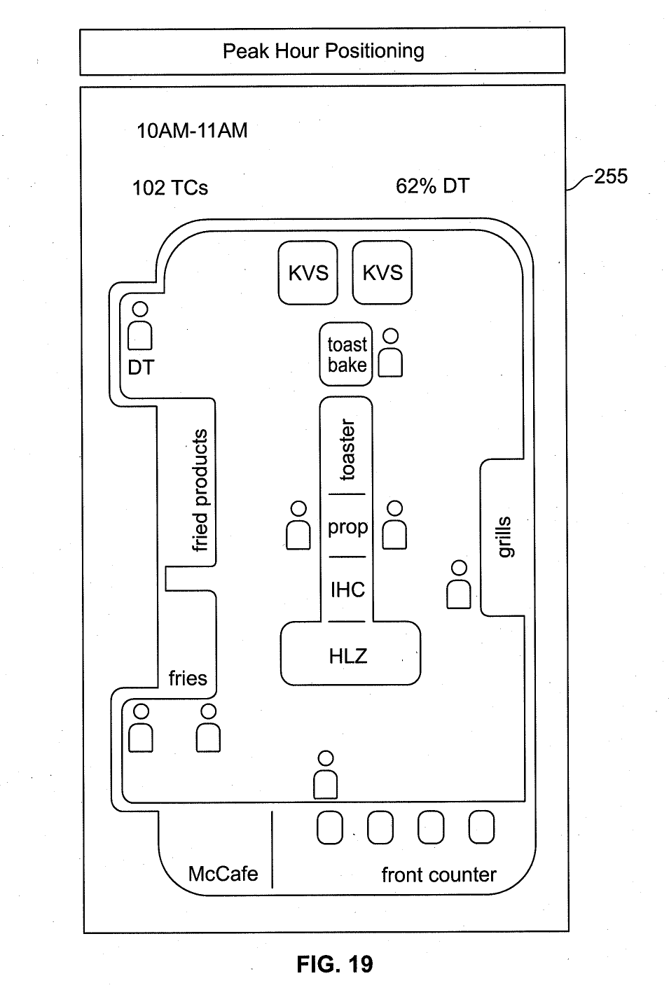

Once all of the options have been selected, a user may generate a positioning guide for that restaurant and for the selected shift by selecting button 202. A representative DSPG 101 that results from selecting button 202 is shown in FIG. 14, with optional detail as shown in FIGS. 15-18. DSPG 101 may graphically display positioning schedule 250 for each hour of the shift. DSPG 101 may also graphically display employee position assignments overlaid on a graphical layout of the restaurant. Positioning schedule 250 may also show total crew graphic 251 showing actual and projected total crew number requirements, by time increment. Positioning schedule 250 may further include utilization graphic 252, which may graphically show the highest and lowest utilized work areas per time increment. Positioning schedule 250 may also include sales graphic 253 reflecting projected and actual sales information for the restaurant during the shift.

Turning to FIG. 16, there is shown a representative positioning schedule 280 of DSPG 101 reflecting the secondary duties that may be available should customer demand permit for each hour of the shift. In one embodiment, DSPG 101 may display two or more staffing scenarios side by side for a given shift to allow a user, such as a shift manager, to perform “what-if” comparisons and to quickly identify which scenario may be more appropriate given his or her experience.

It should be noted that DSPG 101 may be configured to dynamically display in real-time any of the information shown, based on real-time updates to any of the input data being fed into DSPT 100.

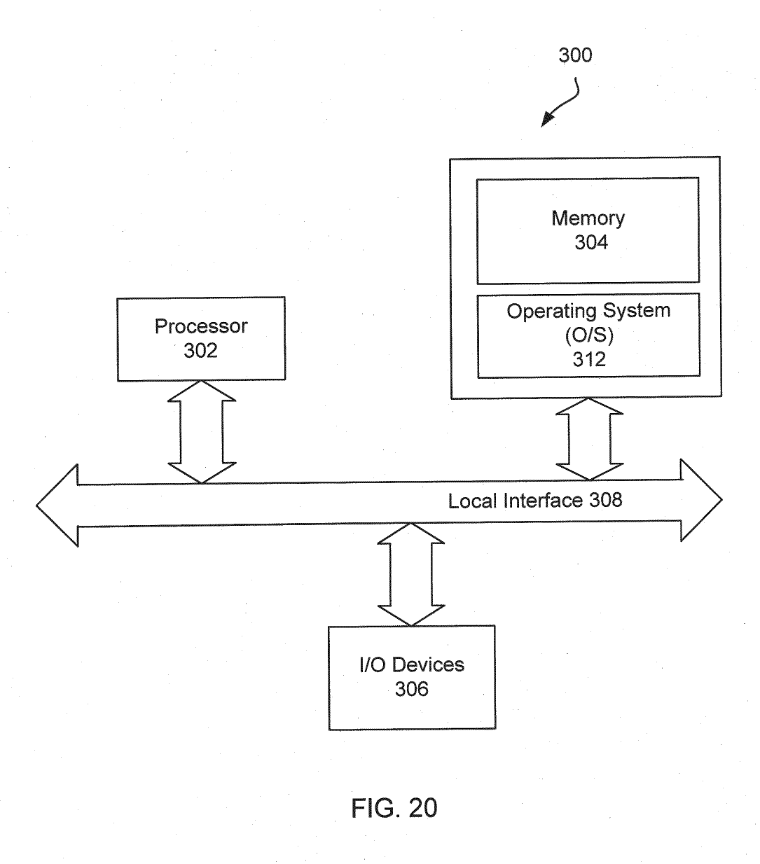

Generally, in terms of hardware architecture, as shown in FIG. 20, DSPT 100 may operate on any type or form of computing device, such as computer 300. Computer 300 includes processor 302, memory 304, and one or more input and/or output (I/O) devices 306 (or peripherals) that are communicatively coupled via a local interface 308. Local interface 308 can be, for example, but not limited to, one or more buses or other wired or wireless connections, as is known in the art. Local interface 308 may have additional elements, which are omitted for simplicity, such as controllers, buffers (caches), drivers, repeaters, and receivers, to enable communications. Further, local interface 308 may include address, control, and/or data connections to enable appropriate communications among the other computer components.

Processor 302 is a hardware device for executing software, particularly software stored in memory 304. Processor 302 can be any custom made or commercially available processor, a central processing unit (CPU), an auxiliary processor among several processors associated with the computer 300, a semiconductor based microprocessor (in the form of a microchip or chip set), a macroprocessor, or generally any device for executing software instructions. Examples of suitable commercially available microprocessors are as follows: a PA-RISC series microprocessor from Hewlett-Packard Company, an 80×86 or Pentium series microprocessor from Intel Corporation, a PowerPC microprocessor from IBM, a Sparc microprocessor from Sun Microsystems, Inc., or a 68xxx series microprocessor from Motorola Corporation. Processor 302 may also represent a distributed processing architecture such as, but not limited to, SQL, Smalltalk, APL, KLisp, Snobol, Developer 200, MUMPS/Magic.

Memory 304 can include any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, memory 304 may incorporate electronic, magnetic, optical, and/or other types of storage media. Memory 304 can have a distributed architecture where various components are situated remote from one another, but are still accessed by processor 302.

The software in memory 304 may include one or more separate programs. The separate programs comprise ordered listings of executable instructions for implementing logical functions. In the example of FIG. 20, the software in memory 304 includes DSPT 100 in accordance with an embodiment of the invention, and a suitable operating system (O/S) 312. A non-exhaustive list of examples of suitable commercially available operating systems 312 is as follows: (a) a Windows operating system available from Microsoft Corporation; (b) a Netware operating system available from Novell, Inc.; (c) a Macintosh operating system available from Apple Computer, Inc.; (d) a UNIX operating system, which is available for purchase from many vendors, such as the Hewlett-Packard Company, Sun Microsystems, Inc., and AT&T Corporation; (e) a LINUX operating system, which is freeware that is readily available on the Internet; (f) a run time Vxworks operating system from WindRiver Systems, Inc.; or (g) an appliance-based operating system, such as that implemented in handheld computers or personal digital assistants (PDAs) (e.g., PalmOS available from Palm Computing, Inc., and Windows CE available from Microsoft Corporation). Operating system 312 essentially controls the execution of other computer programs, such as DSPT 100, and provides input-output control, file and data management, memory management, and communication control and related services.

DSPT 100 may be a source program, executable program (object code), script, or any other entity comprising a set of instructions to be performed. When a source program, the program needs to be translated via a compiler, assembler, interpreter, or the like, which may or may not be included within the memory 304, so as to operate properly in connection with the O/S 312. Furthermore, DSPT 100 can be written as (a) an object oriented programming language, which has classes of data and methods, or (b) a procedural programming language, which has routines, subroutines, and/or functions, for example but not limited to, C, C++, Pascal, Basic, Fortran, Cobol, Perl, Java, and Ada. In one embodiment, when installed within the memory 304 of each computer 300, DSPT 100 is written in C/C+/C++ format, and no browser-based software is used. In other embodiments, browser software may be used.

I/O devices 306 may include input devices, for example but not limited to, a keyboard, mouse, scanner, microphone, touch screens, interfaces for various devices, bar code readers, stylus, laser readers, radio-frequency device readers, etc. Furthermore, I/O devices 304 may also include output devices, including, but not limited to, computer displays such as touch screen displays or displays on hand-held devices, facsimile machines, and paper printers. Finally, I/O devices 304 may further include devices that communicate both inputs and outputs, for instance but not limited to, a modulator/demodulator (modem; for accessing another device, system, or network), a radio frequency (RF) or other transceiver, a telephonic interface, a bridge, and a router.

If the computer 300 is a PC, workstation, PDA, or the like, the software in the memory 304 may further include a basic input output system (BIOS) (not shown in FIG. 20). The BIOS is a set of essential software routines that initialize and test hardware at startup, start the O/S 312, and support the transfer of data among the hardware devices. The BIOS is stored in ROM so that the BIOS can be executed when computer 300 is activated.

When computer 300 is in operation, processor 302 is configured to execute software stored within memory 304, to communicate data to and from memory 304, and to generally control operations of computer 300 pursuant to the software. DSPT 100, and the O/S 312, in whole or in part, but typically the latter, are read by processor 302, perhaps buffered within the processor 302, and then executed.

It should be noted that DSPT 100 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. DSPT 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in a computer memory.

In another embodiment, if DSPT 100 is implemented in hardware, DSPT 100 can be implemented with any, or a combination of, the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in the figures, such as FIGS. 1, 3-4, and 20, should be understood as representing modules, segments, or portions of code which include one or more executable instructions for implementing specific logical functions or steps in the process, and alternate implementations are included within the scope of the embodiments of the present invention in which functions may be executed out of order from that shown or discussed, including substantially concurrently or in reverse order, depending on the functionality involved, as would be understood by those having ordinary skill in the art.

While specific embodiments of the invention have been described in detail, it will be appreciated by those skilled in the art that various modifications and alternatives to those details could be developed in light of the overall teachings of the disclosure. Accordingly, the particular invention disclosed is meant to be illustrative only and not limiting as to the scope of the invention which is to be given the full breadth of the appended claims and any equivalents thereof.

What is claimed is:

1. A system for managing restaurant crew member staffing, comprising:
a computer having memory for receiving
configuration data corresponding to a restaurant associated with a group of restaurants,
first data corresponding to a projected consumer demand for items at the restaurant over a time increment, and
second data corresponding to a historical consumer demand for items at the restaurant over the time increment;
a computer-readable medium encoded with a computer program adapted to dynamically determine a quantity of crew members needed and a position for each crew member determined to be needed to staff each of a plurality of work areas at the restaurant over a plurality of the time increments based on the configuration data, the first data, and the second data; and
a computer display for displaying the quantity of crew members needed to meet the projected consumer demand over the plurality of time increments, and the work areas to which each of the determined quantity of crew members should be assigned.

2. The system of claim 1, further comprising a computer-readable medium encoded with a computer program adapted to cause the computer display to simultaneously display for each time increment a plurality of crew member staffing scenarios.

3. The system of claim 1, wherein the configuration data comprises at least one of a relative location of the work areas with respect to one another, work area equipment, order taking configuration of the restaurant, and types of items available to be sold.

4. The system of claim 1, wherein the configuration data comprises a definition of at least one of a drive thru layout, a quantity of front counter registers, a quantity and/or position of grills, a quantity and/or position of fried product fryers, and/or a quantity and/or position of beverage dispensers.

5. The system of claim 1, wherein the first data and the second data comprise a quantity of items per order associated with at least one work area.

6. The system of claim 1, wherein the first data and the second data comprise a plurality of types of items per order.

7. The system of claim 1, wherein the determination of the quantity of crew members needed to staff each of the plurality of work areas comprises a comparison of a projected quantity of items per order to be fulfilled per work area over the time increment to an order fulfillment capacity for each respective work area over the time increment.

8. The system of claim 1, further comprising a computer-readable medium encoded with a computer program adapted to dynamically adjust an order fulfillment capacity for each respective work area of the restaurant over the time increment based on a historical order fulfillment of the group of restaurants.

9. The system of claim 1, further comprising a computer-readable medium encoded with a computer program adapted to dynamically determine a sequence for positioning at the respective work areas each of the crew members determined to be needed.

10. The system of claim 9, wherein the determination of the sequence comprises sorting each of the positioned crew members according to a minimum fulfillment capacity.

11. The system of claim 9, further comprising a computer-readable medium encoded with a computer program adapted to cause the computer display to dynamically display for each time increment a layout of the restaurant together with the sequence and positioning of each of the positioned crew members.

12. A method for managing restaurant crew member staffing, comprising the steps of:
receiving at a computer processor
configuration data corresponding to a restaurant associated with a group of restaurants,
first data corresponding to a projected consumer demand for items at the restaurant over a time increment, and
second data corresponding to a historical consumer demand for items at the restaurant over the time increment;
dynamically determining by the computer processor a quantity of crew members needed and a position for each crew member determined to be needed to staff each of a plurality of work areas at the restaurant over a plurality of the time increments based on the configuration data, the first data, and the second data; and
displaying on a computer display the quantity of crew members needed to meet the projected consumer demand over the plurality of time increments, and the work areas to which each of the determined quantity of crew members should be assigned.

13. The method of claim 12, further comprising the step of displaying a plurality of crew member staffing scenarios on the computer display at the same time.

14. The method of claim 12, wherein the configuration data comprises at least one of a relative location of the work areas with respect to one another, work area equipment, order taking configuration of the restaurant, and types of items available to be sold.

15. The method of claim 12, wherein the configuration data comprises a definition of at least one of a drive thru layout, a quantity of front counter registers, a quantity and/or position of grills, a quantity and/or position of fried product fryers, and/or a quantity and/or position of beverage dispensers.

16. The method of claim 12, wherein the first data and the second data comprise a quantity of items per order associated with at least one work area.

17. The method of claim 12, wherein the first data and the second data comprise a plurality of types of items per order.

18. The method of claim 12, wherein the step of determining the quantity of crew members needed to staff each of the plurality of work areas comprises comparing a projected quantity of items per order to be fulfilled per work area over the time increment to an order fulfillment capacity for each respective work area over the time increment.

19. The method of claim 12, further comprising the step of dynamically determining a sequence for positioning at the respective work areas each of the crew members determined to be needed.

20. The method of claim 19, wherein the step of determining the sequence comprises sorting each of the positioned crew members according to a minimum fulfillment capacity.

21. The method of claim 19, further comprising the step of dynamically displaying for each time increment a layout of the restaurant together with the sequence and positioning of each of the positioned crew members.

22. A computer program product stored on a computer-readable medium, the computer program product having computer-executable code instructions that are executable by a computer processor for managing restaurant crew member staffing and positioning assignments, the computer-executable code instructions comprising:
first code instructions for receiving
configuration data corresponding to a restaurant associated with a group of restaurants,
first data corresponding to a projected consumer demand for items at the restaurant over a time increment, and
second data corresponding to a historical consumer demand for items at the restaurant over the time increment;
second code instructions for dynamically determining a quantity of crew members needed and a position for each crew member determined to be needed to staff each of a plurality of work areas at the restaurant over a plurality of the time increments based on the configuration data, the first data, and the second data; and
third code instructions for displaying on a computer display the quantity of crew members needed to meet the projected consumer demand over the plurality of time increments, and the work areas to which each of the determined quantity of crew members should be assigned.

23. The computer program product of claim 22, further comprising fourth code instructions for simultaneously displaying a plurality of crew member staffing scenarios on the computer display.

24. The computer program product of claim 22, wherein the configuration data comprises at least one of a relative location of the work areas with respect to one another, work area equipment, order taking configuration of the restaurant, and types of items available to be sold.

25. The computer program product of claim 22, wherein the configuration data comprises a definition of at least one of a drive thru layout, a quantity of front counter registers, a quantity and/or position of grills, a quantity and/or position of fried product fryers, and/or a quantity and/or position of beverage dispensers.

26. The computer program product of claim 22, wherein the first data and the second data comprise a quantity of items per order associated with at least one work area.

27. The computer program product of claim 22, wherein the first data and the second data comprise a plurality of types of items per order.

28. The computer program product of claim 22, wherein determining the quantity of crew members needed to staff each of the plurality of work areas comprises comparing a projected quantity of items per order to be fulfilled per work area over the time increment to an order fulfillment capacity for each respective work area over the time increment.

29. The computer program product of claim 22, further comprising fifth code instructions for dynamically determining a sequence for positioning at the respective work areas each of the crew members determined to be needed.

30. The computer program product of claim 29, wherein determining the sequence comprises sorting each of the positioned crew members according to a minimum fulfillment capacity.

31. The computer program product of claim 29, further comprising sixth code instructions for dynamically displaying for each time increment a layout of the restaurant together with the sequence and positioning of each of the positioned crew members.
